(19) United States
(12) Patent Application Publication
(10) Pub. No.: US 2012/0211424 A1
(43) Pub. Date: Aug. 23, 2012

(54) Novel Polymerizable Surfactant Platforms and Uses Thereof

(75) Inventors: Christopher Gabriel, Louisville, CO (US); Douglas Gin, Longmont, CO (US); Evan Hatakeyama, Hillsboro, OR (US); Brian Wiesenauer, Boulder, CO (US)

(73) Assignee: The Regents of the University of Colorado, a body corporate

(21) Appl. No.: 13/358,296

(22) Filed: Jan. 25, 2012

Related U.S. Application Data
(60) Provisional application No. 61/435,946, filed on Jan. 25, 2011.

(51) Int. Cl. B01D 71/76; B01D 61/02; B01D 67/00; B01D 69/12

(52) U.S. Cl. 210/654; 210/500.27; 210/650; 427/244

(57) ABSTRACT

The invention comprises a cross-linkable lyotropic (i.e., surfactant) liquid crystal (LLC) monomer platform that forms type I bicontinuous cubic (Q_{I}) polymer networks containing 3-D interconnected nanopores.

### CROSS-REFERENCE TO RELATED APPLICATION

The present application is entitled to priority under 35 U.S.C. §119(e) to U.S. Provisional Application No. 61/435,946, filed Jan. 25, 2011, which application is hereby incorporated by reference herein in its entirety.

### STATEMENT REGARDING FEDERALLY SPONSORED RESEARCH OR DEVELOPMENT

This invention was made with government support under grant number CBET0853554 awarded by the National Science Foundation. The government has certain rights in the invention.

### BACKGROUND OF THE INVENTION

This invention relates generally to the field of nanoporous materials based on the cross-linking of lyotropic liquid crystal (LLC) compositions and mixtures. These materials may be used for selective molecular-size based membrane separations. More specifically, this invention relates to the development of a new, more economical, and more easily synthesized LLC monomer that forms bicontinuous cubic LLC networks with 3-D interconnected fluid-filled nanopores that are ideal for separation and transport applications.

Cross-linked lyotropic (i.e., amphiphilic or surfactant) liquid crystal (LLC) assemblies are a class of ordered, nanoporous polymer materials shown to be useful for a number of important applications (O'Brien et al., 1998, Ace, Chem. Res. 31:861; Gin et al., 2001, Acc. Chem. Res, 34:973; Mueller et al., 2002, Chem. Rev. 102:727; Gin et al., 2006, Adv. Funct. Mater, 16:865). These polymers are formed by the in situ polymerization or cross-linking of reactive amphiphiles (i.e., surfactants) that self-organize in water (or another polar liquid) into ordered yet mobile phase-separated assemblies containing periodic, fluid-filled, nanometer-scale domains. LLC phase domains can range in shape from closed spheres to 1-D cylinders and 2-D lamellae, and even 3-D interconnected networks. Unlike morphologically-similar nanoporous polymers made directly from phase-separated block copolymers, or by resin replica-synthesis using phase-separated block copolymers as templates, LLC networks have pores that are significantly smaller (i.e., ≦1 to 10 nm size range), fluid-filled, and lined with the hydrophilic headgroups of the constituent amphiphiles (Gin et al., 2008, Macramol, Rapid Commun. 29:367; Liu et al., 1998, Adv. Mater. 10:69; Urbas et al., 2002, Adv. Mater, 14:1850; Wolf et al., 2003, Langmuir 19:6553; Yang et al., 2006, Adv. Mater. 18:709). This latter feature allows for convenient nanopore functionalization and pore environment tuning (Mueller et al., 2002, Chem. Rev, 102:727; Gin et al., 2006, Adv. Funct. Mater. 16:865). Because of these unique structural features, LLC polymer networks have been demonstrated in templated nanocomposite synthesis, heterogeneous catalysis, molecular size-based membrane separation, and biomolecule or drug encapsulation/release applications (Menger et al., 2005, Angew. Chem. Int. Ed. 44:7053; Zhang et al., 2005, J. Am. Chem. Soc. 127:13508; Xing et al., 2007, Adv. Funct. Mater. 17:2455).

One of the most important and sought-after types of cross-linked LLC assemblies are those with a bicontinuous cubic (Q) structure. Q phases (like other LLC phases) can be classified as type I (i.e., normal) or type II (i.e., inverted) depending on whether the hydrophilic-hydrophobic interface curves away from or towards the polar liquid, respectively. In these systems, the open-framework 3-D interconnected pore systems can provide better accessibility for catalysis and transport compared to lower dimensionality LLC phases such as the cylindrical hexagonal and 2-D lamellar phases. Also, there is no need for bulk sample or pore alignment in these systems for transport applications because of their cubic symmetry. Recent work with Q_{I}-phase polymer membranes and non-polymerized Q-phase ion-conducting materials have experimentally verified these statements (Lu et al., 2006, Adv. Mater. 18:3294; Thou et al., 2007, J. Am. Chem. Soc. 129:9574; Lu et al., 2008, J. Membr. Sci. 318:397; Ichikawa et al., 2007, J. Am. Chem. Soc. 129:10662). Another interesting feature of certain cross-linked Q_{I} phases is that that sub-1-nm pores can be achieved. This latter feature has made Q_{I}-phase LLC networks unique and valuable materials because they can be used for molecular-size based membrane separations (i.e., water desalination, selective/breathable chemical vapor protection) (Zhou et al., 2007, J. Am. Chem. Soc. 129:9574; Lu et al., 2008, J. Membr. Sci. 318:397).

International Patent Application Publication No. WO 98/30318 to Gin et al. states that polymer membranes can be formed from amphiphilic LLC monomers that will self-organize into stable, inverse hexagonal phases in the presence of pure water or other hydrophilic solutions. It was further stated that in situ photopolymerization of the hydrophobic tails into a heavily cross-linked network with retention of the template microstructure yields a robust polymer network with highly uniform pores arranged in a regular hexagonal array. International Patent Application Publication No. WO 2004/060531 to Gin et al. similarly reports composite membranes comprising a porous support and an LLC polymer porous membrane attached to the support and methods for making such membranes. U.S. Patent Application Publication No, 2009/0173693 to Gin et al. reports that composite membranes utilizing LLC monomers can be used for water desalination and nanofiltration.

Unfortunately, only a very small number of prior LLC monomer systems that form polymerizable Q phases are known. O'Brien and co-workers pioneered the development of three polymerizable Q_{II}-phase LLC platforms that are based on mono- and doubly-reactive derivatives of natural phosholipids (Lee et al., 1995, J. Am. Chem. Soc. 117:5573) or glycerol-based amphiphiles (Srisiri et al., 1998, Langmuir 14:1921; Jeong et al., 2002, Langmuir 18:1073; Yang et al., 2002, J. Am. Chem. Soc. 124:13388). Unfortunately, the phospholipid-based systems involve fairly demanding syntheses and can only be produced on a very small scale because of the expense and availability of the phospholipid starting material. In the case of glycerol-based monomers, the syntheses use more available starting materials (i.e., glycerol derivatives); however, in both cases, careful blending of the monomers is required to obtain the desired Q_{II} phases. Yang et al. (J. Am. Chem. Soc. 2002, 124:13388) also disclosed a monomer that can form a Q_{II} phase without blending and is intrinsically cross-linkable, but the doubly reactive tail is synthetically complex to produce.

Q_{I}-phase-forming LLC monomers that are based on an intrinsically cross-linkable gemini phosphonium surfactant platform have also been developed (Pindzola et al., 2003, J. Am. Chem. Soc. 125:2940). Although this first-generation Q_{I} monomer system can be directly photo-cross-linked into a Q_{I} network with a Pn3m or la3d structure for important membrane applications, its synthesis requires an expensive diphosphinedisulfide starting material; pyrophoric phosphine intermediates and reagents (e.g., sodium metal/liquid NH₃); and multiple high- and low-temperature reaction steps to form the bridged hydrophilic phosphonium headgroups. In addition, the initial Q_{I}-phase, monomer-water phases typically involved processing at high pressures (i.e., via a 12-ton press) and elevated temperatures (≧70° C.) to generate supported films for applications (U.S. Patent Application Publication No. 2009/0173693 to Gin et al.). These processing conditions put significant limitations on the amount, cost, and scalability of monomers and the resulting Q_{I}-phase LLC networks.

Therefore, a need continues to exist in the art for a more economical and more easily synthesized cross-linkable LLC monomer platform, preferably one that forms type I bicontinuous cubic (Q_{I}) polymer networks containing 3-D interconnected nanopores that are ideal for highly selective membrane and transport applications. The present invention addresses this need.

### BRIEF SUMMARY OF THE INVENTION

The invention includes a composite membrane comprising: a porous support, and a porous LLC polymer composition attached to the support; wherein the LLC polymer composition forms a type I bicontinuous cubic LLC phase, wherein the phase has a pore structure of interconnected nanopores based on the type I bicontinuous cubic LLC structure and has an effective pore size that ranges from about 0.5 nm to about 5 nm.

In one embodiment, the LLC polymer composition is formed by polymerizing a mixture comprising an aqueous or polar solvent and at least one ammonium-based Gemini amphiphilic monomer. In another embodiment, the LLC polymer composition is embedded within the support. In yet another embodiment, the LLC polymer composition forms a layer on the surface of the support. In yet another embodiment, the effective pore size of the LLC polymer composition ranges from about 0.5 nm to about 2 nm. In yet another embodiment, the pore size of the support ranges from about 0.1 μm to about 10 μm. In yet another embodiment, the at least one amphiphilic monomer has the structure:

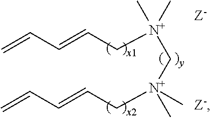

wherein: each occurrence of x1 and x2 is independently an integer ranging from 2 to 20;
y is an integer ranging from 1 to 10; and Z⁻ is an acceptable anion.

The invention also includes a method of preparing a composite membrane, wherein the membrane comprises a porous support and a porous LLC polymer composition embedded within the support. The method comprises providing a porous support. The method further comprises providing a LLC mixture comprising a plurality of polymerizable amphiphilic monomers, a polymerization initiator, and an aqueous or polar organic solvent, wherein one or more of the amphiphilic monomers assembles to form a type I bicontinuous cubic LLC phase. The method further comprises impregnating the support with the LLC mixture. The method further comprises cross-linking the LLC monomers, wherein the type I bicontinuous cubic LLC phase is substantially maintained dining impregnation and cross-linking.

In one embodiment, the plurality of the polymerizable amphiphilic monomers comprises at least one ammonium-based Gemini amphiphilic monomer. In another embodiment, the support is impregnated with the LLC mixture by applying heat and/or pressure to the support and LLC mixture. In yet another embodiment, the support is hydrophilic. In yet another embodiment, the pore size of the support ranges from about 0.5 μm to 10 μm. In yet another embodiment, the LLC mixture does not comprise a separate hydrophobic polymer. In yet another embodiment, the at least one amphiphilic monomer has the structure:

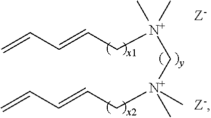

wherein: each occurrence of x1 and x2 is independently an integer ranging from 2 to 20;
y is an integer ranging from 1 to 10; and Z⁻ is an acceptable anion.

The invention also includes a method of preparing a composite membrane, wherein the composite membrane comprises a porous support and a porous LLC polymer composition forming a layer on the surface of the support. The method comprises providing a porous support. The method further comprises providing a LLC mixture comprising a plurality of polymerizable amphiphilic monomers, a polymerization initiator, and an aqueous or polar solvent, wherein one or more of the amphiphilic monomers assemble to form a type I bicontinuous cubic LLC phase. The method further comprises applying a layer of the LLC mixture onto the support. The method further comprises cross-linking the LLC monomers, wherein the type I continuous cubic LLC phase is substantially maintained during impregnation and cross-linking.

In one embodiment, the plurality of polymerizable amphiphilic monomers comprises at least one polymerizable ammonium-based Gemini amphiphilic monomer. In another embodiment, the support is hydrophilic. In yet another embodiment, the pore size of the support ranges from about 0.5 μm to 10 μm. In yet another embodiment, the LLC mixture does not comprise a separate hydrophobic polymer. In yet another embodiment, one or more amphiphilic monomer have the structure:

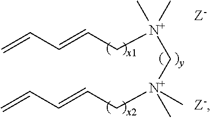

wherein: each occurrence of x1 and x2 is independently an integer ranging from 2 to 20;
y is an integer ranging from 1 to 10; and Z⁻ is an acceptable anion.

The invention also includes a method of separating a given component from a first fluid mixture. The invention comprises contacting a first fluid mixture with the inlet side of a composite membrane of the invention, wherein the first fluid mixture comprises a given component. The invention further comprises applying a pressure difference across the composite membrane. The invention further comprises isolating from the outlet side of the composite membrane a second fluid mixture, wherein the proportion of the given component in the second fluid mixture is depleted as compared with the first fluid mixture.

In one embodiment, the effective pore size of the composite membrane is smaller than the molecular size of the given component.

### BRIEF DESCRIPTION OF THE FIGURES

FIG. 1 is an illustration of the phase progression of LLC phases formed by surfactants in water, and some common LLC phase designations.

FIG. 2, comprising FIGS. 2A-2B, is a schematic representation of the most common (FIG. 2A) type I (normal) and (FIG. 2B) type II (inverted) Q LLC phases. The gray regions are organic domains formed by the LLC tails; the white open regions are the aqueous fluid domains.

FIG. 3 illustrates chemical structures of LLC monomer systems that form and can be cross-linked in either the Q_{II} or the Q_{I} phases.

FIG. 4 illustrates a synthesis scheme for preparation of homologues of a Gemini phosphonium LLC monomer.

FIG. 5 illustrates a synthesis scheme for preparation of homologues of the Gemini ammonium LLC monomers of the present invention.

FIG. 6, comprising FIGS. 6A-6B, illustrates phase diagrams of monomer 4c (x=10, y=3) from FIG. 5 with water (FIG. 6A); and monomer 4f (x=10, y=6) from FIG. 5 with water (FIG. 6B). (Iso=micelles or a discontinuous cubic phase; H=hexagonal phase; L=lamellar phase; Q=bicontinuous cubic phase; X=crystalline phase; Mix=mixture of LLC and crystalline phases.)

FIG. 7, comprising FIGS. 7A-7B, illustrates PLM and XRD profiles for Q_{I} phases of monomers 4c and 4f from FIG. 5 containing 15 wt % water before and after UV photo-cross-linking. FIG. 7A illustrates the Q_{I} phase of monomer 4c after photo-cross-linking; FIG. 7B illustrates the Q_{I} phase of monomer 4c before photo-cross-linking; FIG. 7C illustrates the Q_{I} phase of monomer 4f after photo-cross-linking; and FIG. 7D illustrates the Q_{I} phase of monomer 4f before photo-cross-linking. Q phases are optically isotropic (have a black optical texture) when viewed with the PLM.

FIG. 8 illustrates the preparation of supported, cross-linked Q_{I}-phase LLC membranes on Solupor® E075-9H01A support via hot-pressing and free radical photopolymerization at elevated temperatures. (Each grid square in the illustration is 0.25×0.25 inches in size.)

FIG. 9 illustrates XRD profiles of (curve a) a piece of blank Solupor® E075-9H01A support (dotted line); (curve b) a photo-cross-linked supported Q_{I} membrane on Solupor® E075-9H01A (solid line); and (curve c) the supported Q_{I} membrane after subtraction of the baseline XRD spectrum of the blank Solupor® E075-9H01A support film.

FIG. 10 is a digital photo illustrating the custom-made, stainless steel, 25-mm internal diameter, stirred dead-end filtration cell used in high-pressure water NF and desalination studies.

FIG. 11 illustrates blending experiments, showing penetration scans of a 1:1 molar mixture of gemini imidazolium and gemini ammonium monomers.

### DETAILED DESCRIPTION OF THE INVENTION

The invention relates to cross-linkable lyotropic (i.e., surfactant) liquid crystal (LLC) monomer platforms that form type I bicontinuous cubic (Q_{I}) polymer networks containing 3-D interconnected nanopores. These platforms are ideal for highly selective membrane and transport applications. The cross-linkable, ammonium-based gemini amphiphilic monomers use inexpensive, commercially available starting materials to form the hydrophilic headgroups, and involve less demanding synthesis procedures compared to prior Q_{I}-phase monomer system. Several homologues of this monomer platform form Q_{I} phases with water at relatively low temperatures and ambient pressure. This new monomer system is not only more scalable and industrially viable, but the resulting Q_{I} monomer-water phases can also be processed under milder conditions than prior systems.

### DEFINITIONS

As used herein, each of the following terms has the meaning associated with it in this section.

As used herein, unless defined otherwise, all technical and scientific terms generally have the same meaning as commonly understood by one of ordinary skill in the art to which this invention belongs. Generally, the nomenclature used herein and the laboratory procedures in cell culture, molecular genetics, organic chemistry, and peptide chemistry are those well-known and commonly employed in the art.

As used herein, the articles “a” and “an” refer to one or to more than one (i.e. to at least one) of the grammatical object of the article. By way of example, “an element” means one element or more than one element.

As used herein, the term “about” will be understood by persons of ordinary skill in the art and will vary to some extent on the context in which it is used. As used herein, “about” when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

As used herein, the term “comprising” includes “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements.

As used herein, the term “polymer” refers to a molecule composed of repeating structural units typically connected by covalent chemical bonds. The term “polymer” is also meant to include the terms copolymer and oligomers.

As used herein, the term “polymerization” or “cross-linking” refers to at least one reaction that consumes at least one functional group in a monomeric molecule (or monomer), oligomeric molecule (or oligomer) or polymeric molecule (or polymer), to create at least one chemical linkage between at least two distinct molecules (e.g., intermolecular bond), at least one chemical linkage within the same molecule (e.g., intramolecular bond), or any combination thereof. A polymerization or cross-linking reaction may consume between about 0% and about 100% of the at least one functional group available in the system. In one embodiment, polymerization or cross-linking of at least one functional group results in about 100% consumption of the at least one functional group. In another embodiment, polymerization or cross-linking of at least one functional group results in less than about 100% consumption of the at least one functional group.

As used herein, “liquid crystal” (LC) is a state of matter that has properties between those of a conventional non-ordered liquid and those of an ordered solid crystal. For instance, an LC may flow like a liquid, but its molecules may be generally oriented in a way similar to a crystal lattice.

A “lyotropic liquid crystal” (LLC) consists of two or more components that exhibit liquid-crystalline properties in certain concentration ranges with an added liquid. For example, amphiphilic molecules having two immiscible hydrophilic and hydrophobic parts within the same molecule show lyotropic liquid-crystalline phase sequences depending on the volume balances between the hydrophilic part and hydrophobic parts. The liquid crystal structures are formed through the micro-phase segregation of the two incompatible components on the nanometer scale. In the lyotropic phases, solvent molecules fill the space around the amphiphilic molecules to provide fluidity to the system.

As used herein, “nanoporous” and “nanostructured” refer to a structure having a pore size between about 0.5 and about 5 nm in diameter and a “nanofiltration membrane” has an effective pore size between about 0.5 and about 5 nm. “Ultraporous” signifies a pore size between about 2.5 and about 120 nm and an “ultrafiltration membrane” has an effective pore size between about 2.5 and about 120 nm. “Microporous” signifies a pore size between about 45 nm and about 2500 nm and a “microfiltration membrane” has an effective pore size between about 45 nm and about 2500 nm. As used herein, “nanometer scale dimension” refers to pore dimensions between about 0.5 and about 5 nm.

As used herein, the effective pore size of a membrane is the pore size of the part of the membrane which performs most of the separation function. In an embodiment of the composite nanofiltration membranes of the invention, the LLC polymer portion of the composite is nanoporous while the porous support has a larger average pore size. In an embodiment, the LLC polymer composition has an effective pore size between about 0.5 nm and 5.0 nm. In other embodiments, the effective pore size greater than or equal to 0.5 nm to less than 2 nm, from 0.5 nm to 1 nm, or less than 1 nm.

As used herein, “LLC monomers” are polymerizable amphiphilic molecules that spontaneously self-assemble into fluid, yet highly ordered matrices with regular geometries of nanometer scale dimension when combined with water or another suitable polar organic solvent. LLC mesogens are amphiphilic molecules comprising one or more hydrophobic organic tails and a hydrophilic headgroup. In one embodiment, the headgroup is ionic.

As used herein, a “polymerizable LLC monomer” comprises a polymerizable group which allows covalent bonding of the monomer to another molecule such as another monomer, polymer or crosslinking agent. When the polymerizable group is attached to or part of the organic tail, the organic tails may be linked together during polymerization. Suitable polymerizable groups include acrylate, methacrylate, 1,3-diene, vinyl, (halovinyl), styrenes, vinylether, hydroxy groups, epoxy or other oxiranes (halooxirane), dienoyls, diacetylenes, styrenes, terminal olefins, isocyanides, acrylamides, and cinnamoyl groups. In one embodiment, the polymerizable group is an acrylate, methacrylate, or 1,3-diene group.

As used herein, a “LLC polymer composition” comprises polymerized or cross-linked lyotropic liquid crystal (LLC) monomers in an ordered assembly. As used herein, “LLC monomers” are polymerizable amphiphilic molecules that spontaneously self-assemble into fluid, yet highly ordered matrices with regular geometries of nanometer scale dimension when combined with water or another suitable polar organic solvent. “LLC mesogens” are amphiphilic molecules containing one or more hydrophobic organic tails and a hydrophilic headgroup. As used herein, a “polymerizable LLC monomer” comprises a polymerizable group which allows covalent bonding of the monomer to another molecule such as another monomer, polymer or cross-linking agent. Suitable polymerizable groups include acrylate, methacrylate, 1,3-diene, vinyl, (halovinyl), styrenes, vinylether, hydroxy groups, epoxy or other oxiranes (halooxirane), dienoyls, diacetylenes, styrenes, terminal olefins, isocyanides, acrylamides, and cinamoyl groups. In an embodiment, the polymerizable group is an acrylate, methacrylate or 1,3-diene group. The LLC polymer composition may also comprise an initiator and/or a cross-linking agent.

As used herein, a “monodisperse” pore size has a variation in pore size from one pore to another of less than ca. 15% (specifically, an ideally narrow Poisson distribution). For pore manifold systems formed by some LLC phases (e.g., bicontinuous cubic phases), the pore size of a given pore varies along the pore channel. For pores which dimensions vary along the pore channel, a comparison of pore sizes is made at equivalent positions along the channel. In one embodiment, the pore size is mono-disperse when measured in this way. In one embodiment, the pore size may be measured by its minimum dimension. In one embodiment, the effective pore size of the structure may be determined by the size of the solute that can be excluded from the pore manifold.

As used herein, a “membrane” is a barrier separating two fluids that allows transport between the fluids. Porous LLC polymer membranes useful for the invention comprise a porous LLC polymer. In one embodiment, the membrane to be modified is a “composite” membrane comprising a porous LLC polymer composition combined with a porous support. In one embodiment, the porous LLC polymer membrane is a nanoporous membrane.

As used herein, a “fluid” may be a liquid or a gas.

As used herein, the term “electromagnetic radiation” includes radiation of one or more frequencies encompassed within the electromagnetic spectrum. Non-limiting examples of electromagnetic radiation comprise gamma radiation, X-ray radiation, UV radiation, visible radiation, infrared radiation, microwave radiation, radio waves, and electron beam (e-beam) radiation. In one aspect, electromagnetic radiation comprises ultraviolet radiation (wavelength from about 10 nm to about 400 nm), visible radiation (wavelength from about 400 nm to about 750 nm) or infrared radiation (radiation wavelength from about 750 nm to about 300,000 nm). Ultraviolet or UV light as described herein includes UVA light, which generally has wavelengths between about 320 and about 400 nm, UVB light, which generally has wavelengths between about 290 nm and about 320 nm, and UVC light, which generally has wavelengths between about 200 nm and about 290 nm. UV light may include UVA, UVB, or UVC light alone or in combination with other type of UV light. In one embodiment, the UV light source emits light between about 350 nm and about 400 nm. In some embodiments, the UV light source emits light between about 400 nm and about 500 nm.

As used herein, the term “Type (I) photoinitiator” refers to a compound that undergoes a unimolecular bond cleavage upon irradiation to yield free radicals. Non-limiting examples of Type (I) photoinitiators are benzoin ethers, benzyl ketals, α-dialkoxy-acetophenones, α-hydroxy-alkylphenones, α-amino-alkylphenones and acyl-phosphine oxides.

As used herein, the term “Type (II) photoinitiator” refers to a combination of compounds that undergo a bimolecular reaction where the excited state of the photoinitiator interacts with a second molecule (often known as “co-initiator”) to generate free radicals.

As used herein, the term “instructional material” includes a publication, a recording, a diagram, or any other medium of expression that may be used to communicate the usefulness of the compositions of the invention. In one embodiment, the instructional material may be part of a kit useful for generating a system of the invention. The instructional material of the kit may, for example, be affixed to a container that contains the compositions of the invention or be shipped together with a container that contains the compositions. Alternatively, the instructional material may be shipped separately from the container with the intention that the recipient uses the instructional material and the compositions cooperatively. For example, the instructional material is for use of a kit; instructions for use of the compositions; or instructions for use of a formulation of the compositions.

Throughout this disclosure, various aspects of the invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range and, when appropriate, partial integers of the numerical values within ranges. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Disclosure

The present invention includes nanoporous QI-phase LLC networks using an ammonium-based cross-linkable LLC monomer platform. The invention provides inexpensive starting materials for hydrophilic headgroup synthesis and less demanding synthesis procedures than previously known methods, including methods utilizing phosphonium methods. A number of ammonium-based gemini surfactants and LLCs have been reported in the literature (Fuller et al., 1996, Langmuir 12:1117; Zana et al., 2007, J. Dispersion Sci. Techno. 28:143; Zana, 2002, J. Colloid Interfac. Sci. 248:203); however, polymerizable versions of these compounds that form cross-linked Q phases are unprecedented. Several homologues based on the monomer platform of the present invention were found to form Q_{I} phases with water at ≧ca. 50° C. and atmospheric pressure. The resulting Q_{I}-phase monomer-water mixtures can be more easily processed into films under milder conditions than prior Q_{I} monomers, particularly phosphonium monomers. Consequently, this second-generation gemini LLC monomer system is more scalable and more industrially viable than prior Q_{I} monomer systems. In addition, the ammonium-based cross-linkable LLC monomers provided herein may form other LLC phases with non-aqueous solvents instead of water.

### Compositions of the Invention

In one aspect, the present invention provides a polymerizable amphiphilic monomer comprising an ammonium-based gemini head group and a hydrophobic tail group attached to each nitrogen of the head group.

In one embodiment, the ammonium-based gemini head group comprises two quaternary amines linked together through a linking group. The linking group is a substituted or unsubstituted carbon chain having between 1 and 10 carbon atoms. Each hydrophobic tail group is a substituted or unsubstituted carbon chain having from 2 to 20 carbon atoms and may be linear or branched. The hydrophobic tail groups attached to the head group may be the same or different from one another. In one embodiment, the tail group comprises acrylate, methacrylate, 1,3-diene, vinyl, (halovinyl), styrenes, vinylether, hydroxy groups, epoxy or other oxiranes (halooxirane), dicnoyls, diacetylenes, styrenes, terminal olefins, isocyanides, acrylamides, and cinnamoyl groups. In another embodiment, the tail group comprises an acrylate, vinly, methacrylate or 1,3-diene group. In yet another embodiment, the tail group comprises a 1,3-diene. The hydrophobic tail group can have some portions that are more hydrophobic than others, but the tail group is overall hydrophobic with respect to the head group portion of the molecule. In one embodiment, the tail group does not comprise an acrylate.

In one embodiment, the present invention includes a polymerizable amphiphilic monomer having the structure:

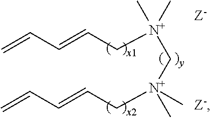

wherein xi and x2, independently of one another, are integers from 2 to 20, and y is an integer from 1 to 10. Z⁻ is an acceptable anion, including but not limited to the halide anions, such as fluoride, chloride, bromide, and iodide, as well as acetate, sulfates, and trifluoroacetate. In another embodiment, x1 and x2, independently of one another, are integers from 4 to 14, more preferably from 6 to 10. Preferably, y is an integer from 3 to 6. In another embodiment, x1 and x2 are the same.

The amphiphilic monomer can polymerize in an aqueous or polar solution to create a nanostructured and porous LLC composition in which the arrangement, size, and chemical properties of the pores may be tailored on the molecular level by using the polymerizable monomers as building blocks. The LLC polymer composition may be used to form a membrane and, in particular, may be combined with a porous support to form a composite membrane. These compositions can act as novel nanoporous membranes capable of selectively removing nanometer-size impurities, organic molecules, certain ions, and other contaminants from solutions based solely on molecular size. In addition, the incorporation of chemical complexing agents in the nanopores of these materials can enable other forms of separation processes.

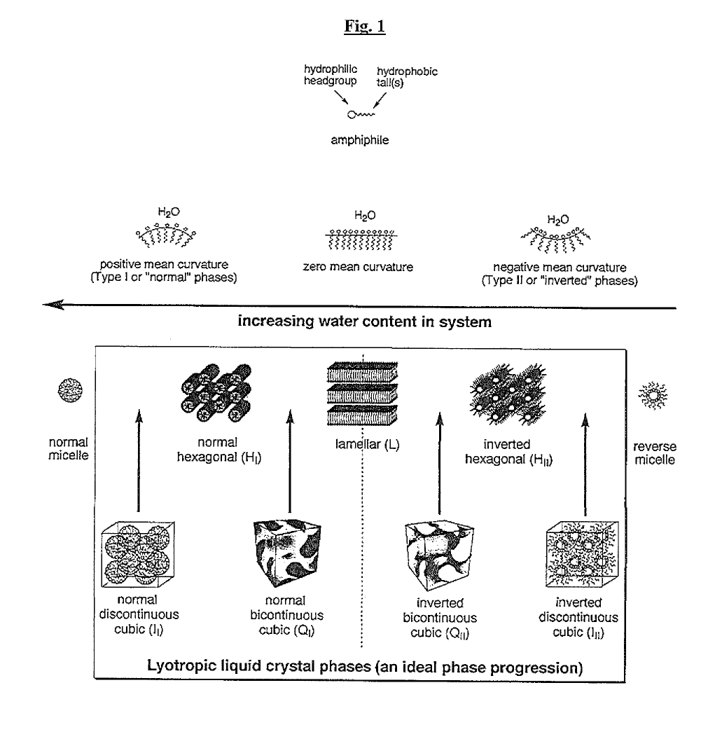

In a further embodiment, the invention provides a composite nanofiltration membrane comprising: a porous support and a porous LLC polymer composition attached to the support. In another embodiment, the composite nanofiltration membrane comprises a porous support and a porous cross-linked LLC polymer composition embedded within and/or on top of the support, with the LLC polymer composition comprising a pore structure of interconnected pores. The LLC polymer composition is formed by the polymerization of an ammonium-based gemini amphiphilic monomer and a solvent, wherein the LLC polymer composition forms a type I (normal type) bicontinuous cubic (Q_{I}) LLC phase (FIG. 1) having a pore structure of interconnected nanopores based on the Q_{I} LLC structure. A hydrophobic polymer is not required to form the LLC phase structure and preferably the polymer composition does not include a hydrophobic polymer. The LLC polymer composition can be embedded within the pores of the support or formed on the surface of the support. Preferably, the polymerizable LLC monomers are assembled in Q_{I} phase prior to polymerization.

In one embodiment, the pores of the LLC polymer composition may be filled with water, an aqueous solution, a polar organic solvent, or a polar organic solvent solution. The membranes of the invention are believed to provide a unique alternative to biological membranes with water-filled, nanometer-sized pores.

The composite membranes of the invention are useful for separation processes involving aqueous and non-aqueous solutions as well as gases. In one embodiment, the membranes of the invention are suitable for filtration of aqueous solutions. For example, the composite membranes of the invention can be useful for water desalination, allowing rejection of dissolved salts such as NaCl, MgCl₂, and CaCl₂. In one embodiment, the membranes of the present invention are capable of rejecting greater than 90% of NaCl, MgCl₂, or CaCl₂ in an aqueous solution, preferably 94% or greater, or more preferably 95% or greater. The composite membranes of the invention are also useful for nanofiltration of neutral molecules and macromolecules and molecular ions in the 0.64-1.2 nm size range from water. The composite membrane can also be made in flexible form, which allows it to be used in a variety of membrane configurations (e.g., spiral-wound).

In a further embodiment, the amphiphilic monomers of the composite membranes and methods described above have the structure:

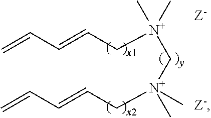

wherein x1 and x2, independently of one another, are integers from 2 to 20; and y is an integer from 1 to 10. Z⁻ is an acceptable anion, including but not limited to the halide anions, such as fluoride, chloride, bromide, and iodide, as well as acetate, sulfates, and trifluoroacetate. Preferably, x1 and x2, independently of one another, are integers from 4 to 14, more preferably from 6 to 10, and y is an integer from 3 to 6.

In one embodiment, the LLC compositions and mixtures of the present invention comprise between 60% and 95% of the amphiphilic monomer by weight, preferably between 75% and 90%, more preferably between 80% and 90%.

As illustrated in FIG. 1, the content of water or other solvent molecules changes the self-assembled structures. At very low amphiphile concentration, the molecules is dispersed randomly without any ordering. At slightly higher (but still low) concentration, amphiphilic molecules assemble into micelles or vesicles. This is done to ‘hide’ the hydrophobic tail of the amphiphile inside the micelle core, exposing a hydrophilic (water-soluble) surface to aqueous solution. These micelles and vesicles generally do not order themselves in the solution. At higher concentrations, the assemblies become ordered, such as in a hexagonal columnar phase, where the amphiphiles form long cylinders (again with a hydrophilic surface facing the aqueous solution) that arrange themselves into a roughly hexagonal lattice. At still higher concentrations, a lamellar phase may form, wherein extended sheets of amphiphiles are separated by thin layers of water. For some systems, a cubic (also called viscous isotropic) phase may exist between the hexagonal and lamellar phases, wherein spheres are formed that create a dense cubic lattice. These spheres may also be connected to one another, forming a bicontinuous cubic phase. For some systems, at high concentrations, inverse phases are observed. That is, one may generate an inverse hexagonal columnar phase (columns of water encapsulated by amphiphiles) or an inverse micellar phase (a bulk liquid crystal sample with spherical water cavities).

LLC monomers useful for the present invention are those that form a bicontinuous cubic LC phase in the presence of water or other polar solvents. The bicontinuous cubic LC phase contains ordered nanopores of water or another polar organic solvent. LLC monomers useful for the present invention can be polymerized into a cross-linked network with substantial retention of the original LC phase microstructure. The LLC phase structure may be a polydomain structure, and therefore may display short-range rather than long-range order.

LLC monomers useful for the present invention can form solvent nanopores having a diameter between about 0.5 and about 5 nm. For pore manifold systems formed by some LLC phases (e.g. bicontinuous cubic phases), the pore size of a given pore varies along the pore channel. For pores whose dimensions vary along the pore channel, a comparison of pore sizes is made at equivalent positions along the channel. In one embodiment, the pore size is monodisperse when measured in this way. In another embodiment, the pore size may be measured by its minimum dimension.

In these systems, the open-framework 3-D interconnected pore systems provide better accessibility for catalysis and transport compared to lower-dimensionality LLC phases such as the cylindrical hexagonal and 2-D lamellar phases. Also, there is no need for bulk sample or pore alignment in these systems for transport applications because of their cubic symmetry. Certain cross-linked Q_{I} phases can also achieve sub-1-nm pores. This latter feature has made Q_{I}-phase LLC networks unique and valuable materials because they can be used for molecular-size based membrane separations (i.e., water desalination, selective/breathable chemical vapor protection).

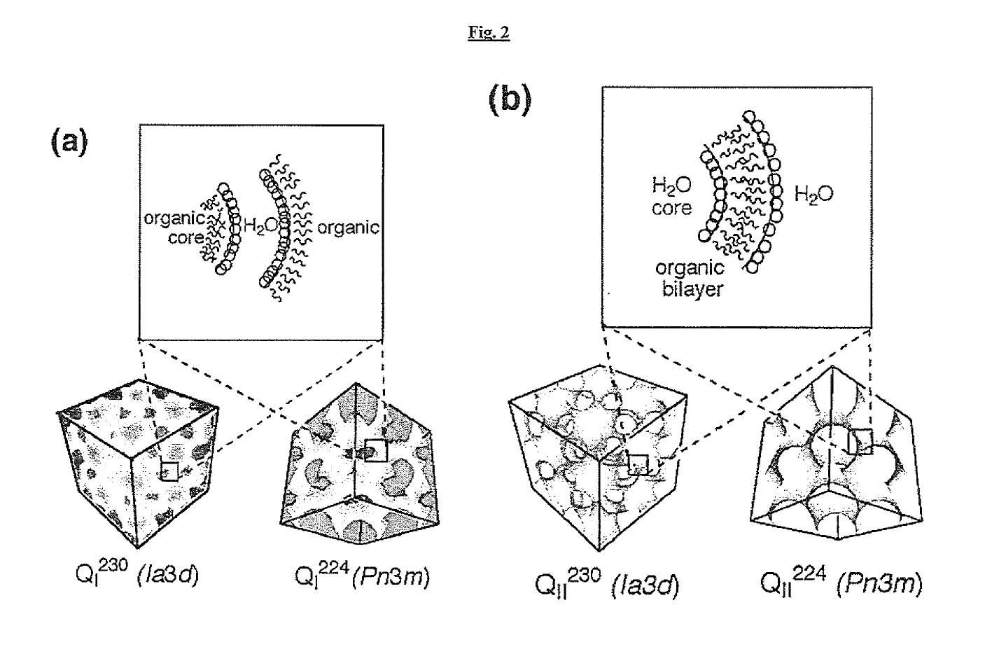

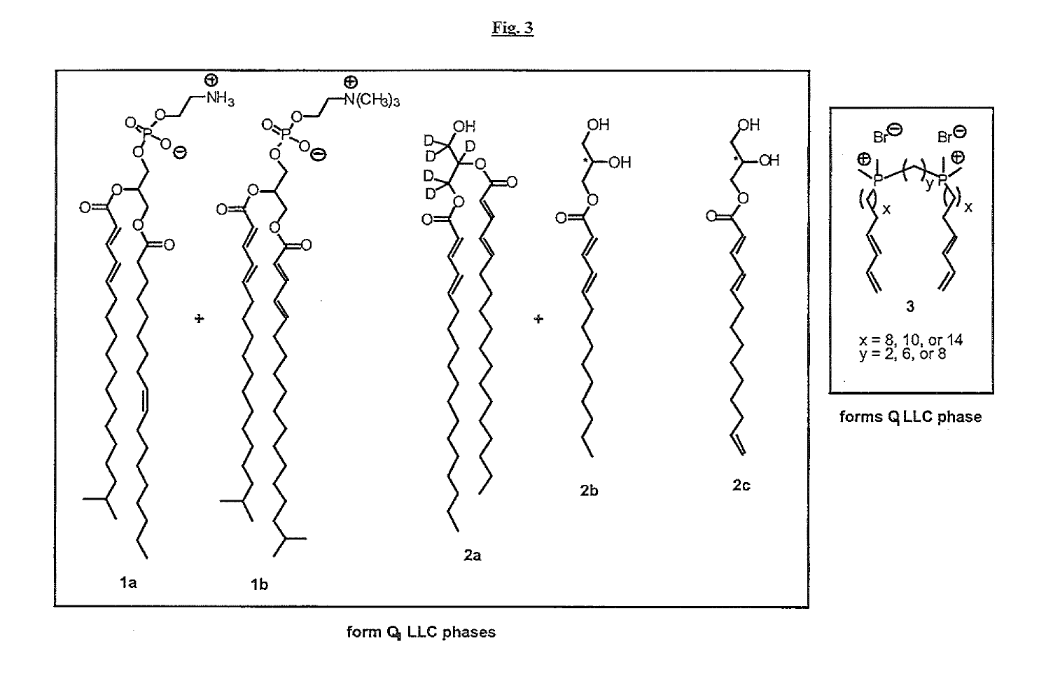

Polymerizable LLCs (i.e., cross-linkable surfactants) have been designed that spontaneously form type I bicontinuous cubic phases in the presence of a small amount of water or other polar solvent. A number of bicontinuous cubic (Q) phases have been identified; these phases are termed bicontinuous because they have two or more unconnected but interpenetrating hydrophobic and/or aqueous networks with overall cubic symmetry. Q phases (like other LLC phases) can be classified as type I (i.e., normal; FIG. 2A) or type II (i.e., inverted; FIG. 2B), depending on whether the hydrophilic-hydrophobic interface curves away from or towards the polar liquid, respectively. The polymerizable LLCs used in the practice of certain embodiments of the invention form a Q_{I} phase in the presence of water. For Q_{I} phases, the size of the gap between the organic portions of the structure determines the effective pore size of the structure for size exclusion of solutes. The effective pore size of the structure may be determined by the size of the solute which can be excluded from the pore manifold.

Typically, the pore structure after polymerization is substantially determined or controlled by the Q phase which is formed by the monomers. In this case the pore structure may be said to be based on the bicontinuous cubic LLC structure. The pore structure after polymerization need not be identical to that of the bicontinuous cubic LLC phase. In some LLC phases, contraction of the structure is observed on heavy cross-linking of the polymer into a network. Expansion of Q_{I} unit cells has been observed for some LLC monomers (Pindzola et al., 2003, J. Ant Chem. Soc. 125(10):2940-2949). Some disordering of the phases may also be observed upon cross-linking, as evidenced by a loss in powder X-ray diffraction (XRD) peak intensity (Pindzola et al., 2003, J. Am. Chem. Soc. 125(10),2940-2949). In an embodiment, the pore structure of the polymerized network retains at least part of the bicontinuous cubic phase structure and comprises interconnected, ordered 3-D nanopores. Retention of the bicontinuous cubic phase structure can be confirmed through observation of XRD peaks characteristic of the structure.

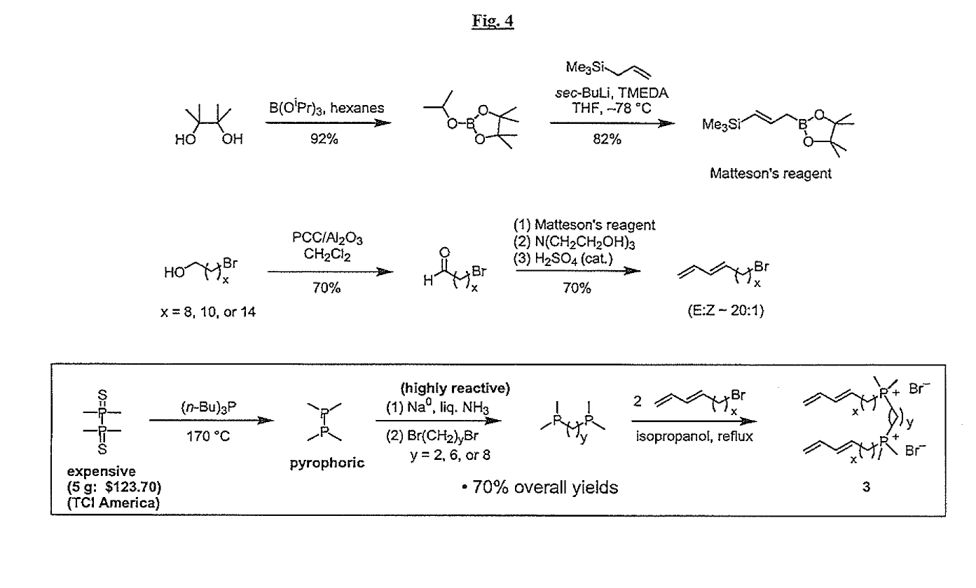

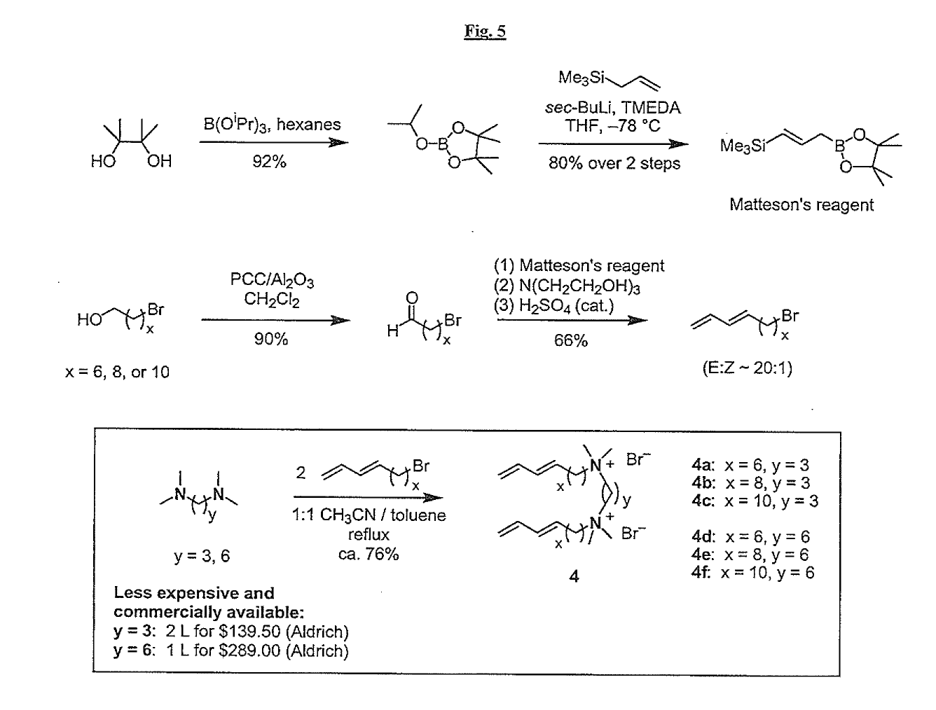

The cross-linkable, gemini ammonium Q_{I}-phase LLC platform (monomer 4 shown in FIG. 5) described in the present invention uses inexpensive, commercially available starting materials to form the hydrophilic headgroups, and involves less demanding synthesis procedures compared to the prior phosphonium Q_{I}-phase monomer systems. Several homologues based on monomer platform 4 were found to form Q_{I} phases with water at ≧ca. 50° C. and atmospheric pressure. The resulting Q_{I}-phase monomer 4-water mixtures can be more easily processed into films under milder conditions than prior Q_{I} monomers (monomer 3 in FIG. 4). In addition, homologues of monomer 4 were found to be able to form other LLC phases with nonaqueous solvents instead of water. A number of ammonium-based gemini surfactants and LLCs have been reported in the literature; however, polymerizable versions that form cross-linked Q phases are unprecedented. Several homologues of this monomer platform form Q_{I} phases with water at relatively low temperatures and ambient pressure. This new monomer system is not only more scalable and industrially viable, but the resulting Q_{I} monomer-water phases can also be processed under milder conditions than the prior system.

As summarized in FIG. 5, the synthesis of this new cross-linkable Gemini ammonium LLC platform utilizes commercially available and relatively inexpensive alkyl-bridged tetramethyldiamines for the gemini ionic headgroup synthesis. In addition, instead of multiple steps requiring high and low temperatures and expensive and/or pyrophoric phosphine reagents, formation of homologues of the new monomer 4 just requires a single high-yield reaction between the commercial bridged diamines and two equivalents of the polymerizable ω-bromoalkyl-1,3-diene tail units. This represents a significant cost-savings and more facile production of this monomer compared to monomer 3. It should be noted that for the compounds illustrated in FIG. 4 and FIG. 5, “x” is the same for both tails (i.e., x1=x2=x).

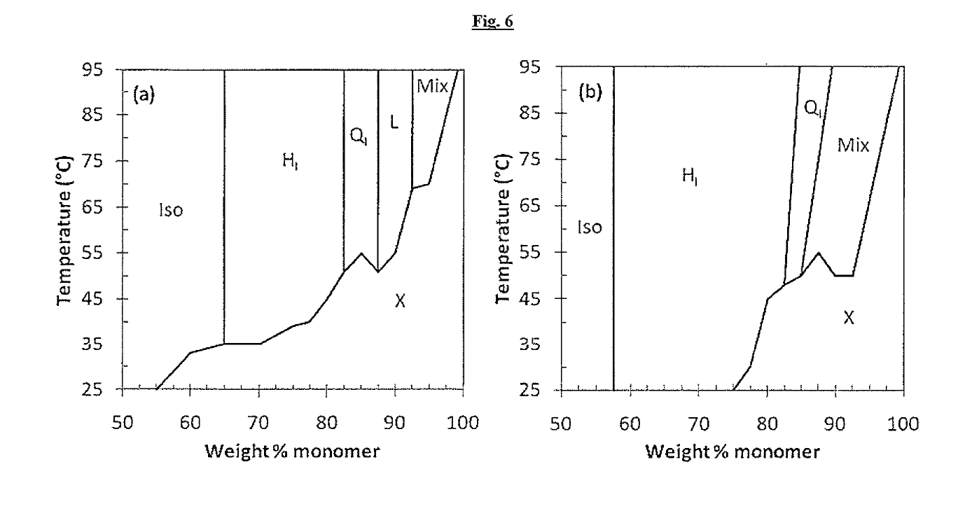

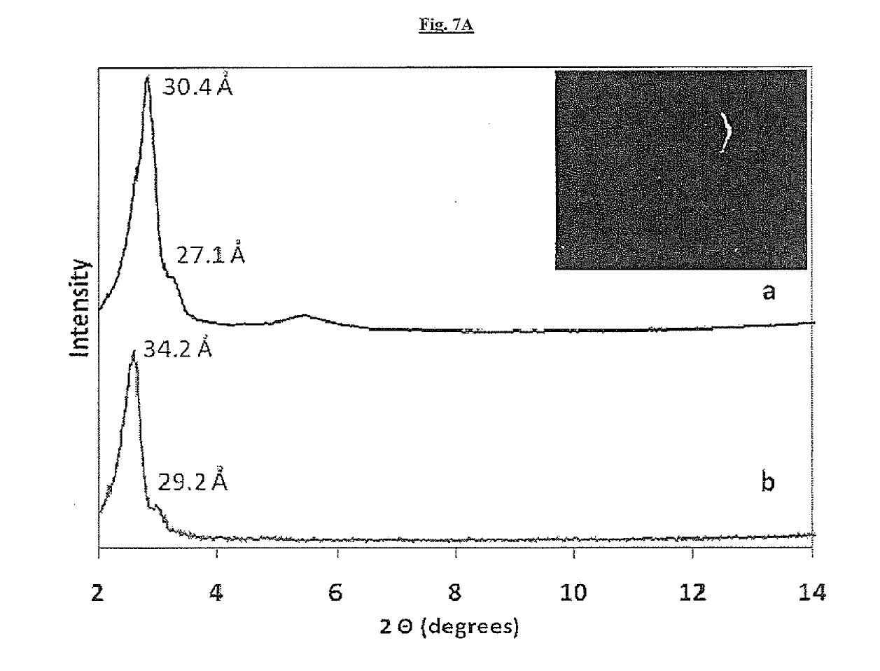

Of the six homologues of monomer 4 synthesized as shown in FIG. 5, two monomers (4c and 4f) were found to form Q_{I} phases with water. The complete phase diagrams of 4c and 4f with water are shown in FIG. 6. The identity of the LLC phases were elucidated by a combination of variable-temperature polarized light microscopy (PLM) and powder X-ray diffraction (XRD) analysis as known in the art. For identification of Q phases, the requirements are a black PLM optical texture (pseudoisotropic), and the presence of XRD peaks in the d-spacing ratio 1/√6, 1/√8, etc. In addition, Q phases are thick, viscous, optically transparent gels under normal light. The Q phases observed in the phase diagrams of monomers 4c and 4f are labeled as being type I (Le., normal) phases because they lie on the water-excessive side of an observed L phase. The other four homologues of monomer 4 only showed L and HI phases but no Q phases.

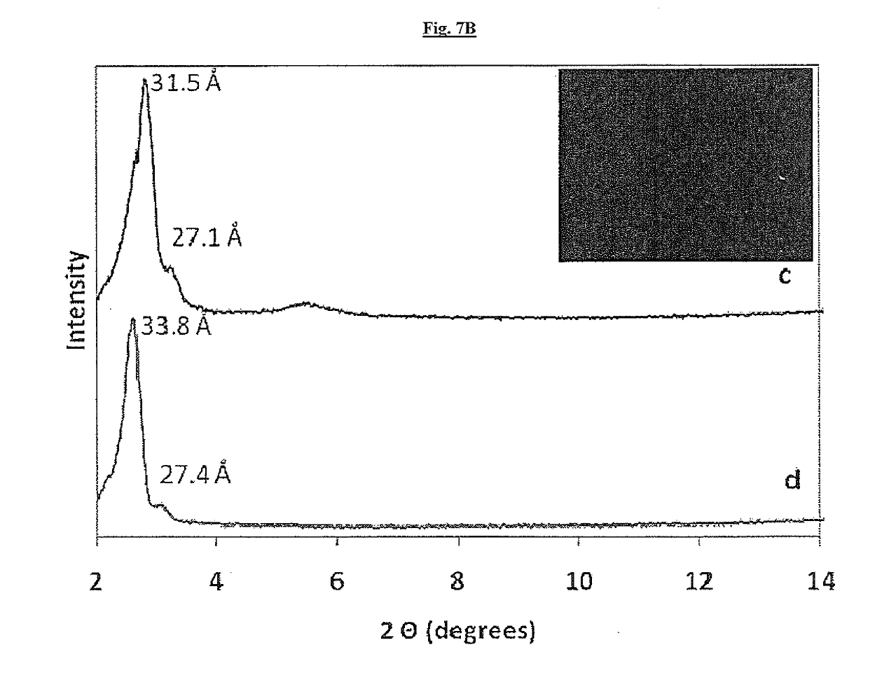

The Q_{I} phases formed by 4c and 4f with water can be pressed into thin films at temperatures ≧50° C. (see Q_{I} phase regions in phase diagrams in FIG. 6) using manual hand pressures between Mylar sheets. In one embodiment, the processing temperature is below 70° C. In another embodiment, the processing temperature is between 50° C. and 95° C., preferably between 50° C. and 70° C., more preferably between 50° C. and 65° C. These film processing conditions are substantially less demanding than the high-pressure, 70° C. film pressing/processing conditions used for homologues of gemini phosphonium monomer 3 (Lu et al., 2006, Adv. Mater. 18:3294; Zhou et al., 2007, J. Am. Chem. Soc. 129:9574). When maintained at ≧50° C., the resulting pressed films can be photo-cross-linked using added radical photo-initiators and 365 nm UV light to lock-in the Q_{I} phase structure. In order to illustrate this polymerization behavior, FIG. 7 shows the XRD and PLM spectra for representative samples of Q_{I} phases of monomers 4c and 4f each containing 15 wt % water, before and after photo-cross-linking. When viewed with PLM, Q phases are optically isotropic (black) as seen in FIGS. 7a and 7c. FIG. 7 shows that retention of the Q_{I}-phase structure is retained after photo-cross-linking in both systems. The only noticeable change in the materials after photo-cross-linking, other than sample solidification, was a slight volume contraction. The degree of 1,3-diene tail conversion during photopolymerization was >90% according to FT-IR analysis, as described in prior papers (Lu et al., 2006, Adv. Mater. 18:3294; Zhou et al., 2007, J. Am. Chem. Soc. 129:9574). The main benefits of using Gemini ammonium LLC monomers such as 4c and 4f over prior phosphonium monomers are simplicity and more economical synthesis and processing.

Preferably, the pores of the LLC polymer compositions of the present invention are hydrophilic. These pores may be filled with water or an aqueous solution. The pores of the LLC polymer composition may be filled with water or an aqueous solution by using these liquids as the solvent in the LLC mixture. Alternatively, the solvents used in the LLC mixture may be replaced with water or the aqueous solution of interest after polymerization of the LLC mixture.

In one embodiment, the LLC polymer composition is embedded or located within the pores of the support. In the portions of the support containing the LLC polymer composition, the LLC polymer composition fills enough of the pore space of the support so that separation process is controlled by the pores of the LLC polymer composition. Preferably, there are no “non-LLC” pores with a pore size greater than that of the LLC polymer composition which traverses the composite membrane. In one embodiment, the LLC polymer composition is present throughout the thickness of the support, so that the thickness of the composite membrane may be taken as the thickness of the support. During fabrication of the composite membrane, the LLC mixture may be applied to only a portion of the surface of the support. The LLC polymer composition may be retained within the support by mechanical interlocking of the LLC polymer composition with the support.

In one embodiment, the LLC polymer composition forms a layer on the surface of the support; this layer acts as a membrane. In another embodiment, the thickness of this layer is less than 10 μm, less than 5 μm, less than 2 μm, less than 1 μm, or less than 0.5 μm. In yet another embodiment, the LLC polymer composition is embedded within the pores of the support in addition to forming a layer on the surface of the support.

In an embodiment, the porous support is hydrophilic. As used herein, a hydrophilic support is wettable by water and capable of spontaneously absorbing water. The hydrophilic nature of the support can be measured by various methods known to those skilled in the art, including measurement of the contact angle of a drop of water placed on the membrane surface, the water absorbency (weight of water absorbed relative to the total weight, U.S. Pat. No. 4,720,343) and the wicking speed (U.S. Pat. No. 7,125,493). The observed macroscopic contact angle of a drop of water placed on the support surface may change with time. In one embodiment, the contact angle of a 2 μL drop of water placed on the support surface (measured within 30 seconds) is less than 90 degrees, from 5 degrees to 85 degrees, zero degrees to thirty degrees or is about 70 degrees. In one embodiment, the support is fully wetted by water and soaks all the way through the support after about one minute. Hydrophilic polymeric supports include supports formed of hydrophilic polymers and supports which have been modified to make them hydrophilic. In another embodiment, the support can be hydrophobic.

Typically, the porous support has a smaller flow resistance than the LLC membrane. In one embodiment, the porous support in this system is selected so that the diameter of the pores is less than about 10 μm and greater than the effective pore size of the LLC polymer composition. In another embodiment, the support is microporous or ultraporous. In yet another embodiment, the support has a pore size less than about 0.1 μm or from 0.1 μm to 10 μm. The preferred pore size of the support may depend on the composition of the LLC mixture. The characteristic pore size of the porous support may depend on the method used to measure the pore size. Methods used in the art to determine the pore size of membranes include Scanning Electron Microscopy analysis, capillary flow porometry analysis (which gives a mean flow pore size), measurement of the bubble pressure (which gives the largest flow pore size), and porosimetry.

The porous support gives physical strength to the composite structure and can also add flexibility to the composite membrane. The support should also be thermally stable over approximately the same temperature range as the LLC membranes to be used.

The support is selected to be compatible with the solution used for LC membrane formation, as well as to be compatible with the liquid or gas to be filtered. When the solution used for LC membrane fabrication and the support are compatible, the support is resistant to swelling and degradation by the solution used to cast the LC polymer porous membrane. In one embodiment, the organic solvent used in the solution and the support are selected to be compatible so that the support is substantially resistant to swelling and degradation by the organic solvent. Swelling and/or degradation of the support by the solvent can lead to changes in the pore structure of the support. In one embodiment, if the membrane is to be used for water based separations, the porous support is sufficiently hydrophilic for water permeation.

The porous support may be made of any suitable material known to those skilled in the art including polymers, metals, and ceramics. In one embodiment, the porous polymer support comprises polyethylene (including high-molecular-weight and ultra-high-molecular-weight polyethylene), polyacrylonitrile (PAN), polyacrylonitrile-copolyacrylate, polyacrylonitrile-co-methylacrylate, polysulfone (PSf), Nylon 6,6, poly(vinylidene difluoride), or polycarbonate. In another embodiment, the support may be a polyethylene support or a support of another polymer mentioned above (which may include surface treatments to affect the wettability of the support). In yet another embodiment, the support is a micropore polyethylene support such as Solupor® E075-9H01A. The support may also be an inorganic support such as a nanoporous alumina disc (Anopore J Whatman, Ann Arbor, Mich.). The porous support may also be a composite membrane.

The flux rate through the composite membrane as a whole depends upon the pressure differential applied across the membrane as well as on the permeability of the LLC polymer membrane and membrane thickness. The composite membranes of the invention are capable of sustaining pressure differences of greater than 100 psi or greater than 400 psi and obtaining aqueous solution flux rates greater than about 0.005 or 0.01 L.m⁻².h⁻¹ for a pressure differential of 60 psi and 0.005 or 0.060 L.m⁻².h⁻¹ for a pressure differential of 400 psi. In one embodiment, a composite membrane having a thickness of approximately 40 μm has a thickness-normalized water permeability of greater than 0.04, 0.06, or 0.08 L.m⁻².h⁻¹.bar⁻¹.μm.

Furthermore, the LLC polymer membrane can be fabricated with chemical complexing agents in the nanopores. These chemical complexing agents may be inorganic or organic entities that have the ability to interact reversibly or irreversibly with various solutes that enter the membrane. These chemical complexing agents may include, but are not limited to, metal ions such as Cu⁺, Cu²⁺, Ag⁺, Co²⁺, Sc³⁺, and amine functionalities. However, incorporation of these agents may change the effective pore size of the membrane.

In one embodiment, the solution used for applying the LLC monomer, also known as the “LLC mixture”, comprises a plurality of polymerizable LLC monomers, an aqueous or polar organic solvent or solution thereof, and a polymerization initiator. A single species of polymerizable LLC monomer may be used, but a plurality of monomers is required for phase formation. The aqueous or polar solvent is selected so that the LLC monomer forms the desired Q^{I} phase. Because of the LLC phase formation, the solution formed may not be uniform. The mixture components do not include the porous support. In one embodiment, suitable polar liquid solvents include, but are not limited to water, dimethylformamide, and THF and room-temperature ionic liquids (RTILs).

RTILs are polar, molten organic salts under ambient conditions that are typically based on substituted imidazolium, phosphonium, ammonium, and related organic cations complemented by a relatively non-basic and non-nucleophilic large anion. In one embodiment, suitable polar organic solvents suitable as water substitutes for LLC assembly include ethylene glycol, glycerol, formamide, N-methylformamide, dimethylformamide, and N-methylsydnone, most of which are fairly water-miscible, protie organic solvents with the exception of N-methylsydnone. In one embodiment, the solvent is aqueous. The polymerization initiator can be photolytically or thermally activated. The mixture is thoroughly combined. In one embodiment, mixing may be performed through a combination of hand mixing and centrifuging.

In an embodiment, the LLC mixture does not further comprise a hydrophobic polymer as described by Lu et al. (Lu et al., 2006, Adv. Mater. 18:3294) and U.S. Pat. No. 7,090,788. As used herein, a polymer is a substance composed of macromolecules, the structure of which essentially comprises the multiple repetition of units derived from molecules of low relative molecular mass.

The LLC mixture may further comprise an optional cross-linking agent molecule to help promote intermolecular bonding between polymer chains. The cross-linking agent is not required if the monomer can cross-link without a cross-linking agent. In one embodiment, the cross-linking agent is not a polymer. In one embodiment, the cross-linking agent has less than 10 Monomeric repeat units and/or has a weight less than 500 Daltons. Typically, the cross-linking agent or curing agent is a small molecule or monomeric cross linker such as divinyl benzene (DVB). Cross-linking agents are known to those skilled in the art. The amount of cross-linking agent is small enough to allow formation of the desired Q_{I} LLC phase. The cross-linker will typically be hydrophobic, in order to dissolve in and help to cross-link the hydrophobic tail regions of the Q_{I} LLC phase. For water filtration applications, it is believed that the incorporation of additional hydrophobic components into the LLC mixture should be limited to prevent the overall polymeric composition from being too hydrophobic for good water filtration. In one embodiment, the maximum amount of cross-linking agent is 10 wt % to 15 wt %. In one embodiment, when the cross-linking agent is hydrophobic its size is kept small enough so that reduction of the overall density or surface coverage of the polar solvent (e.g. water) nanopores is limited. The LLC mixture often has a fluid gel-like consistency before cross-linking or polymerization.

The mixture may further comprise an organic solvent for formulation or delivery of the LLC monomer (e.g. for solvent casting). The solvent may be any low boiling point organic solvent that dissolves the monomer. A mixture of one or more solvents may also be used. Useful solvents include, but are not limited to, methanol and diethyl ether. In one embodiment, the monomer is dissolved in the organic solvent, and then the water and the optional cross-linking agent are added. In one embodiment, the organic solvent used in the solution and the support are selected to be compatible so that the support is substantially resistant to swelling and degradation by the organic solvent. Swelling and/or degradation of the support by the solvent can lead to changes in the pore structure of the support.

The composition of the LLC mixture may be selected to obtain the desired bicontinuous phase based on the phase diagram for the LLC monomer. For example, at atmospheric pressure the LLC phases present in the system may be determined as a function of temperature and percentage of amphiphile (LLC monomer) in the system (e.g., Pindzola et al., 2003, J. Am. Chem. Soc. 125:2940). The percentage of LLC monomer in the mixture and the temperature can then be selected together to obtain the desired bicontinuous cubic phase. When the phase of LLC mixture is sensitive to the water or other solvent content, steps can be taken to minimize evaporative water or solvent loss during the membrane fabrication process.

In one embodiment, the LLC mixture is assembled into the desired bicontinuous cubic phase before the mixture is contacted with the porous support. The mixture may be allowed to rest at room temperature or at any suitable temperature dictated by the phase diagram. Analysis of the LLC phases can be performed by several methods known to those skilled in the art including polarized light microscopy (PLM) and x-ray diffraction (XRO). Q phases are optically isotropic (have a black optical texture) when viewed with the PLM. XRD of Q phases exhibit symmetry-allowed d spacings that ideally proceed in the ratio 1:1/√2:1/√3:1/√4:1/√5:1/√6:1/√7:1/√8:1/√9:1/√10: . . . corresponding to the d₁₀₀, d₁₁₀, d111, d₂₀₀, d₂₁₀, d₂₁₁, d₂₂₀, d₂₂₁ (or d₃₀₀), d₃₁₀, . . . diffraction planes. The presence of Q phases with P or I symmetry in polydomain small molecule amphiphile and phase separated block copolymer systems has generally been identified on the basis of a black optical texture and a powder XRD profile in which the 1/√6 and 1/√8:d spacings (i.e. the d₂₁₁ and d₂₂₀ reflections) are at least present (Pindzola et al., 2003, J. Am. Chem. Soc. 125:2940). The higher order XRD reflections can be used to distinguish between the different 3-D cubic phase architectures, since systematic XRD absences in the XRD peaks result as the cubic cells becomes more complex. However, the higher order reflections may not be observed when the phases do not possess a great deal of long range order.

In one embodiment where the LLC polymeric composition is embedded into the support, a quantity of the LLC mixture is placed on a surface of the porous support and then infused into the porous support. In one aspect of the invention, the support is impregnated with the LLC mixture using a combination of heat and pressure to drive the LLC mixture into the pores of the support. The temperature and pressure are selected so that Q_{I} phase is still retained. The LLC mixture and support may be heated to decrease the viscosity of the LLC mixture before pressure is applied. In one embodiment, a heated press may be used to impregnate the support with the LLC mixture. When a press is used, the LLC mixture and support membrane may be sandwiched between a pair of load transfer plates. Additionally, a pair of polymeric sheets may be used to facilitate release of the support mixture and membrane from the load transfer plates and limit evaporation of water from the mixture. Suitable dense polymeric sheets that are transparent to UV or visible light include, but are not limited to, Mylar® (a biaxially-oriented polyester film made from ethylene glycol and dimethyl teraphthalate). The LLC mixture need not completely fill the pore space of the support, but fills enough of the pore space of the support so that separation process is controlled by the pores of the LLC polymer composition. In one embodiment, the gel is pushed uniformly through the entire support membrane thickness. Application of the LLC composition into the porous support may be accomplished using any method known in the art.

After impregnation of the support with the LLC mixture, the LLC monomers are then cross-linked to form the LLC polymer composition. In one embodiment, the LLC monomers are polymerized by cross-linking of the hydrophobic tails. In one embodiment, the LLC phase can be photo-cross-linked by putting it under UV light in air or nitrogen at ambient temperature (or at the required temperature to maintain the desired LLC phase). Other temperatures as known by those skilled in the art may be used during the cross-linking process. Other methods of cross-linking as known to those skilled in the art may also be used. For example, thermal cross-linking may be performed using a cationic initiator as a cross-linking agent. The degree of cross-linking can be assessed with infrared (IR) spectroscopy. In one embodiment, the degree of polymerization is greater than 90% or greater than 95%.

In other embodiments, the LLC polymer composition is formed as a thin, supported top-film on top of the support. Application of the LLC composition as a film on the surface of the support may be accomplished using any method known in the art. In another embodiment of the present invention, the coating of the LLC monomer mixture can be formed by solution-casting the LLC monomer mixture to make thin films on membrane supports after evaporation of the delivery solvent; doctor-blade drawcasting of the initial viscous Q_{I}-phase LLC monomer gel; or roll-casting of the LLC mixture at elevated temperature. It is preferred that that coating be free of surface defects such as pinholes and scratches. In one embodiment, a commercial foam painting sponge or other such applicator can be used to apply the solution to the support. In another embodiment, the solution can be applied by roller casting. The amount of material on the support can be controlled by the number of applications and the concentration of the casting solution. If desired, more than one layer of solution may be applied to the support to form multiple layers of porous LC polymer and thereby control the film thickness.

Without wishing to be bound by any particular theory, it is believed that some of the solution penetrates into the support, with the extent of penetration depending on the nature of the solution, the support, and the application process. While penetration of the solution may not be necessary to form a stable film on the support, the penetration of the solution into the support is believed to help attach the cross-linked LLC polymer film to the support. When the Q_{I} phase is sensitive to the solvent content of the LLC mixture, the solvent content (e.g. water content) is controlled during processing to maintain the desired Q_{I} phase. In one embodiment, the solvent content can be controlled by limiting evaporation of solvent from the film. Evaporation of the solvent can be controlled by sandwiching the LLC film and support between polymer sheets, processing the LLC film and support in an enclosure in which the atmosphere is controlled (e.g. the humidity level is controlled), and by other methods known to those skilled in the art. Enclosing the LLC film can also prevent other components from entering into LLC monomer film.

In one embodiment, the composition of the invention further comprises at least one photoinitiator: a molecule that, upon irradiation with a given wavelength at a given intensity for a given period of time, generates at least one species capable of catalyzing, triggering or inducing a polymerization or cross-linking. A photoinitiator known in the art may be employed, such as a benzoin ether and a phenone derivative such as benzophenone or diethoxyacetophenone. In one embodiment, the irradiation comprises ultraviolet electromagnetic radiation (wavelength from about 10 nm to about 400 nm), visible electromagnetic radiation (wavelength from about 400 nm to about 750 nm) or infrared electromagnetic radiation (radiation wavelength from about 750 nm to about 300,000 nm). In another embodiment, the electromagnetic radiation comprises ultraviolet or visible electromagnetic radiation.

Ultraviolet or UV light as described herein includes UVA light, which generally has wavelengths between about 320 and about 400 nm, UVB light, which generally has wavelengths between about 290 nm and about 320 nm, and UVC light, which generally has wavelengths between about 200 nm and about 290 nm. UV light may include UVA, UVB, or UVC light alone or in combination with other type of UV light. In one embodiment, the UV light source emits light between about 350 nm and about 400 nm. In some embodiments, the UV light source emits light between about 400 nm and about 500 nm.

Non-limiting examples of the photoinitiator contemplated within the invention are:
1-hydroxy-cyclohexyl-phenyl-ketone (Irgacure™ 184; Ciba, Hawthorne, N.J.);
a 1:1 mixture of 1-hydroxy-cyclohexyl-phenyl-ketone and benzophenone (Irgacure™ 500; Ciba, Hawthorne, N.J.);
2-hydroxy-2-methyl-1-phenyl-1-propanone (Darocur™ 1173; Ciba, Hawthorne, N.J.);
2-hydroxy-1-[4-(2-hydroxyethoxy)phenyl]-2-methyl-1-propanone (Irgacure™ 2959; Ciba, Hawthorne, N.J.);
methyl benzoylformate (Darocur™ MBF; Ciba, Hawthorne, N.J.);
oxy-phenyl-acetic acid 2-[2-oxo-2-phenyl-acetoxy-ethoxy]-ethyl ester;
oxy-phenyl-acetic 2-[2-hydroxy-ethoxy]-ethyl ester;
a mixture of oxy-phenyl-acetic acid 2-[2-oxo-2-phenyl-acetoxy-ethoxy]-ethyl ester and oxy-phenyl-acetic 2-[2-hydroxy-ethoxy]-ethyl ester (Irgacure™ 754; Ciba, Hawthorne, N.J.);
alpha,alpha-dimethoxy-alpha-phenylacetophenone (Irgacure™ 651; Ciba, Hawthorne, N.J.);
2-benzyl-2-(dimethylamino)-1-[4-(4-morpholinyl)-phenyl]-1-butanone (Irgacure™ 369; Ciba, Hawthorne, N.J.);
2-methyl-1-[4-(methylthio)phenyl]-2-(4-morpholinyl)-1-propanone (Irgacure™ 907; Ciba, Hawthorne, N.J.);
a 3:7 mixture of 2-benzyl-2-(dimethylamino)-1-[4-(4-morpholinyl)phenyl]-1-butanone and alpha,alpha-dimethoxy-alpha-phenylacetophenone per weight (Irgacure™ 1300; Ciba, Hawthorne, N.J.);
diphenyl-(2,4,6-trimethylbenzoyl)phosphine oxide (Darocur™ TPO; Ciba, Hawthorne, N.J.);
a 1:1 mixture of diphenyl-(2,4,6-trimethylbenzoyl)-phosphine oxide and 2-hydroxy-2-methyl-1-phenyl-1-propanone (Darocur™ 4265; Ciba, Hawthorne, N.J.);
phenyl bis(2,4,6-trimethyl benzoyl)phosphine oxide, which may be used in pure form (Irgacure™ 819; Ciba, Hawthorne, N.J.) or dispersed in water (45% active, Irgacure™ 819DW; Ciba, Hawthorne, N.J.);
a 2:8 mixture of phosphine oxide, phenyl bis(2,4,6-trimethyl benzoyl) and 2-hydroxy-2-methyl-1-phenyl-1-propanone (Irgacure™ 2022; Ciba, Hawthorne, N.J.);
Irgacure™ 2100, which comprises phenyl-bis(2,4,6-trimethylbenzoyl)-phosphine oxide);
bis-(eta 5-2,4-cyclopentadien-1-yl)-bis-[2,6-difluoro-3-(1H-pyrrol-1-yl)phenyl]-titanium (Irgacure™ 784; Ciba, Hawthorne, N.J.);
(4-methylphenyl) [4-(2-methylpropyl)phenyl]-iodonium hexafluorophosphate (Irgacure™ 250; Ciba, Hawthorne, N.J.);
2-(4-methylbenzyl)-2-(dimethylamino)-1-(4-morpholinophenyl)-butan-1-one (Irgacure™ 379; Ciba, Hawthorne, N.J.);
4-(2-hydroxyethoxy)phenyl-(2-hydroxy-2-propyl)ketone (Irgacure™ 2959; Ciba, Hawthorne, N.J.);
bis-(2,6-dimethoxybenzoyl)-2,4,4-trimethylpentylphosphine oxide;
a mixture of bis-(2,6-dimethoxybenzoyl)-2,4,4-trimethylpentylphosphine oxide and 2-hydroxy-2-methyl-1-phenyl-propanone (Irgacure™ 1700; Ciba, Hawthorne, N.J.);
titanium dioxide; and mixtures thereof.

The photoinitator may be used in amounts ranging from about 0.01 to about 25 weight percent (wt %) of the composition, more preferably from about 0.1 to about 20 weight percent (wt %) of the composition, more preferably from about 1 to about 15 weight percent (wt %) of the composition, more preferably from about 2 to about 10 weight percent (wt %) of the composition.

### METHODS OF THE INVENTION

In one aspect, the invention includes a method of making the LLC compositions and mixtures of the present invention. In one embodiment, the method comprises the steps of reacting a first compound having the structure:

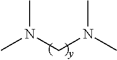

with a second compound having the structure:

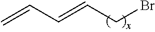

wherein x is an integer from 2 to 20, preferably from 6 to 10, and y is an integer from 1 to 10, preferably from 3 to 6, and wherein the ration of the second compound to the first compound is at least 2:1. In another embodiment, the reaction between the first compound and second compound is carried out at a temperature greater than 50° C., preferably between 50° C. and 80° C., more preferably between 65° C. and 75° C. In yet another embodiment, the product of the reaction between the first compound and second compounds is cooled to form a precipitate which is collected. The collected precipitate (the amphiphilic monomer) can then be mixed with the appropriate solvent and polymerization initiator to form the desired LLC bicontinuous cubic phase.

In another aspect, the invention includes a process of separating a component of a first fluid mixture, comprising the steps of: bringing the first fluid mixture into contact with the inlet side of a composite membrane as described above; applying a pressure difference across the composite membrane; and withdrawing a second fluid mixture from the outlet side of the composite membrane, where the proportion of the component in the second fluid mixture is depleted or reduced compared with the first fluid mixture. Preferably, the effective pore size of the composite membrane is smaller than the molecular size of the component to be removed.

In yet another aspect, the invention provides a method of making a nanofiltration membrane. The method of the invention is simpler than currently available methods of making nanofiltration membranes.

In one embodiment, the method comprises the steps of: providing a porous support, preparing a LLC mixture comprising a plurality of polymerizable ammonium-based gemini amphiphilic monomers, a polymerization initiator and an aqueous or polar organic solvent and not including a separate hydrophobic polymer, wherein at least some of the amphiphilic monomers assemble to form a normal (type I) bicontinuous cubic (i.e., a Q_{I}) LLC phase; impregnating the porous support with the LLC mixture; and cross-linking the LLC monomer.

In one embodiment, the method comprises the steps of: providing a porous support, preparing a LLC mixture comprising a plurality of polymerizable ammonium-based gemini amphiphilic monomers, a polymerization initiator and an aqueous or polar organic solvent and not including a separate hydrophobic polymer, wherein at least some of the amphiphilic monomers assemble to form a LLC phase; applying a layer of the LLC mixture to the support; and cross-linking the LLC monomer.

In one embodiment, the Q_{I} LLC phase is substantially maintained during impregnation/application and cross-linking. In another embodiment, the desired bicontinuous cubic phase is maintained through control of solvent (e.g., water) content and temperature of the LLC mixture.

In one aspect, the invention includes a method of size-selective filtration of solutions using the composite membrane of the invention. One or more components such as nanometersize impurities, organic molecules, certain ions, and other contaminants can be removed from solution by selecting the pore diameter of the LLC membrane to be smaller than the molecular size of the component(s) of interest. Components which can be separated from a fluid mixture using the membranes of the invention include organic molecules, ions, gases, impurities and other contaminants.

In one aspect, the invention includes a method for other forms of separation processes. If a chemical complexing agent is incorporated into the nanopores of the composite membrane of the invention, the chemical complexing agent can interact reversibly or irreversibly with various solutes that enter the membrane. For example, if metal ions such as Cu⁺, Cu²⁺, and Ag⁺ are incorporated into the nanopores, enhanced oxygen separation or separation of olefins from paraffins can be enabled. Amine functionalities would enable enhanced CO₂ separation from other gases. Similarly, the incorporation of water-stable catalytic entities in the nanopores of these materials may also offer the option of catalytically degrading organic waterborne contaminants into more biodegradable forms during the nanofiltration process. The incorporation of chemical complexing or reactive agents into LLCs is known to the art (Gu et al., 2001, Chem. Mater. 13(6):1949-1951.; Gray et al., 1998, Chem. Mater. 10 (7):1827-1832; Deng et al., 1998, J. Am. Chem. Soc. 120(14):3522-3523).

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. Although the description herein contains many embodiments, these should not be construed as limiting the scope of the invention but as merely providing illustrations of some of the presently preferred embodiments of the invention.

It will be obvious to one of ordinary skill in the art that the invention can be performed by modifying or changing, within a wide and equivalent range, the conditions, formulations and other parameters disclosed herein without affecting the scope of the invention or any specific embodiment thereof, and that such modifications or changes are intended to be encompassed within the scope of the appended claims.

When a group of materials, compositions, components or compounds is disclosed herein, it is understood that all individual members of those groups and all subgroups thereof are disclosed separately. When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and sub-ranges, as well as all individual values included in the ranges given are intended to be included in the disclosure. Additionally, the end points in a given range are to be included within the range.

The terms and expressions that have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application. In general the terms and phrases used herein have their art-recognized meaning, which can be found by reference to standard texts, journal references and contexts known to those skilled in the art. Any preceding definitions are provided to clarify their specific use in the context of the invention.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EXAMPLES

The invention is now described with reference to the following Examples. These Examples are provided for the purpose of illustration only, and the invention is not limited to these Examples, but rather encompasses all variations that are evident as a result of the teachings provided herein.

### Reagents, Procedures and Instrumentation

2-Hydroxy-2-methylpropiophenone, N,N,N′,N′-tetramethyl-1,3-propanediamine (99%), and N,N,N′,N′-tetramethyl-1,6-hexanediamine (99%) were all purchased from the Sigma-Aldrich Chemical Company and used as received. 7-Bromo-1-heptanol (>88%) and 9-bromo-1-nonanol (>88%) were purchased from TCI America, and used as received. 11-Bromo-1-undecanol (99.0%) was purchased from Fluka, and used as received. All solvents were purchased from Sigma-Aldrich or Fisher Scientific, and purified/dehydrated via N₂-pressurized activated alumina columns, unless otherwise noted. All chemical syntheses were carried out under a dry argon atmosphere using standard Schlenk line techniques, unless otherwise noted. Chromatographic separations were performed on silica gel (200-400 mesh, 60 Å) using the indicated solvents. The water used in LLC phase formulation was de-ionized and had a resistivity of >12 MΩ.cm⁻¹.

The LLC mixtures were homogenized using an IEC Centra-CL2 centrifuge. Powder and thin film X-ray-diffraction (XRD) spectrums were obtained with an Inel CPS 120 diffraction system equipped with a programmable heated stage and film holder, using monochromated Cu K_{αα} radiation source. All XRD spectra were calibrated against a silver behenate line spacing diffraction standard (d₁₀₀=58 Å). Polarized light microscopy (PLM) studies were performed using a Leica DMRXP polarizing light microscope equipped with a Linkam L TS 350 thermal stage, Linkam CI 94 temperature controller, and a Q-Imaging MicroPublisher 3.3 RTV digital camera. Linkam Linksys32 software was used to automate temperature profiles, and image capturing.

¹H NMR spectra were recorded at 400 or 500 MHz and ¹³C NMR spectra at 100 or 125 MHz using a Varian Inova 400 or 500 instrument as indicated. NMR Chemical shifts are reported in ppm relative to residual non-deuterated solvent. Fourier-transform infrared (FT-IR) spectra were recorded using a Mattson Satellite FT-IR spectrometer. The FT-IR samples were prepared as thin films on Ge crystals. Mass spectral analysis was performed at the Dept. of Chemistry & Biochemistry Mass Spectrometry Facility at the University of Colorado at Boulder.

Photopolymerizations were conducted using a Spectroline XX-15A 365 nm UV lamp (8.5 mW.cm⁻² at the sample surface). UV light fluxes at the samples surfaces were measured with a Spectroline DRC-100× digital radiometer equipped with a DIX-365 UV-A sensor. Photopolymerizations were conducted on a custom-made temperature-controlled hot stage.

### Example 1

### Chemical Compounds

### 10-Bromodeca-1,3-diene

PCC on alumina (24.9 g, 77 mmol, 100 mol %) was added to a solution of 7-bromo-1-heptanol (15.0 g, 76.9 mmol, 100 mol %) in CH₂Cl₂ (250 mL). The reaction mixture was stirred at room temperature for 16 h and then the solvent was removed under reduced pressure (35 mm Hg). The brown residue was stirred in diethyl ether (100 mL) and filtered through a plug of basic alumina and washed with diethyl ether (5×50 mL). The solvent was removed under reduced pressure (35 mm Hg) to afford a 7-bromo-heptanal as a light yellow oil (13.30 g, 89%) that was used without further purification. Matteson's reagent (17.37 g, 72.3 mmol, 105 mol %) was added to a solution of 7-bromo-1-heptanal (13.30 g, 68.9 mmol, 100 mol %) in diethyl ether (125 mL). The reaction was stirred at room temperature for 24 h and then triethanolamine (11.30 g, 10.06 mL, 75.7 mmol, 110 mol %) was added and the reaction was stirred for an addition 2 h. During this time a white precipitate formed. The reaction mixture was washed with saturated NaHCO₃ (2×100 mL), dried with MgSO₄, filtered, and the solvent was removed under reduced pressure (35 mm Hg). The resulting oil was dissolved in THF (100 mL), H₂SO₄ (15 drops) was added, and the reaction was stirred at room temperature for 16 h. The reaction mixture was poured into a separatory funnel, diluted with diethyl ether (100 mL), and washed with saturated NaHCO₃ (2×100 mL). The organic layer was dried with MgSO₄, filtered, and solvent was removed under reduced pressure (35 mm Hg) to afford the crude product as a light yellow oil.

Purification by column chromatography (SiO₂) using hexanes as the eluent afforded the product as a clear colorless oil (11.9 g, 81%). ¹H NMR (400 MHz, CDCl₃): δ 6.34 (ddd, J=17.0, 10.4, 10.1 Hz, 1H), 6.09 (dd, J=15.2, 10.4 Hz, 1H), 5.72 (dt, J=15.2, 7.0 Hz, 1H), 5.11 (d, J=17.0 Hz, 1H), 4.94 (d, J=10.1 Hz, 1H), 3.42 (t, J=6.8 Hz, 2H), 2.12 (m, 2H), 1.83 (m, 2H), 1.41 (m, 6H). ¹³C NMR (101 MHz, CDCl₃): (527.9, 28.4, 28.5, 32.4, 32.8, 34.0, 115.3, 131.4, 135.03, 137.4. IR (neat): 3082, 33, 3010, 2937, 2845, 1792, 1642, 1459, 1350, 1301, 1260, 1197, 1003, 951, 899, 729 cm⁻¹.

### 12-Bromododeca-1,3-diene

Synthesized as described in the literature (Pindzola et al., 2003, J. Am. Chem. Soc. 125:2940). Spectroscopic characterization and purity data for this compound matched published data.

### 14-Bromotetradeca-1,3-diene

Synthesized as described in Pindzola et al., 2003, J. Am. Chem. Soc. 125:2940. Spectroscopic characterization and purity data for this compound matched published data.

### 1,3-Bis(deca-7,9-dienyl-N,N,N′,N′-tetramethylammonium)propane dibromide (monomer 4a)

N,N,N′,N′-Tetramethyl-1,3-propanediamine (0.486 g, 1.10 mL, 6.58 mmol, 100 mol %) and 10-bromodeca-1,3-diene (3.00 g, 13.82 mmol, 210 mol %) were dissolved in toluene (10 mL) and acetonitrile (20 mL) in a 50-mL Schlenk flask equipped with a stir bar. The clear colorless solution was heated to 69° C. for 15 h. The white precipitate that formed after cooling to room temperature was filtered and washed with hexanes (2×10 mL), affording a white powder (3.15 g, 85%). ¹H NMR (400 MHz, CDCl₃): δ 6.31 (dt, J=10.4, 6.4 Hz, 2H), 6.05 (dd, J=10.4, 4.4 Hz, 2H), 5.68 (dd, J=14.6, 7.6 Hz, 2H), 5.10 (d, J=16.8 Hz, 2H), 4.98 (d, J=10.8 Hz, 2H), 3.93 (t, J=8.0 Hz, 4H), 3.50 (m, 4H), 3.36 (s, 12H), 2.78 (s, 2H), 2.08 (m, 4H), 1.77 (m, 10H), 1.39 (bs, 10H). ¹³C NMR (100 MHz, CDCl₃): δ 23.1, 26.3, 28.9, 29.0, 32.5, 45.6, 51.3, 61.1, 66.6, 115.2, 131.4, 135.0, 137.4. IR (thin film, MeOH): 3417, 2926, 2854, 2056, 1649, 1483, 1464, 1003, 949, 897, 588 cm⁻¹. HRMS (ES) calcd. for C₂₇H₅₂BrN₂ (M+M+Br−): 483.3308; observed: 483.3303.

### 1,3-Bis(dodeca-9,11-dienyl-N,N,N′,N′-tetramethylammonium)propane dibromide (monomer 4b)

N,N,N′,N′-Tetramethyl-1,3-propanediamine (0.38 g, 0.48 mL, 2.91 mmol, 100 mol %) and 12-bromododeca-1,3-diene (1.50 g, 6.12 mmol, 210 mol %) were dissolved in toluene (10 mL) and acetonitrile (10 mL) in a 50-mL Schlenk flask equipped with a stir bar. The clear colorless solution was heated to 69° C. for 15 h. The white precipitate that formed after cooling to room temperature was filtered and washed with hexanes (2×10 mL), affording a white powder (1.80 g, 89%). ¹H NMR (400 MHz, CDCl₃): δ 6.29 (dt, J=10.4, 6.4 Hz, 2H), 6.03 (dd, J=10.4, 4.8 Hz, 2H), 5.69 (dd, J=14.4, 6.8 Hz, 2H), 5.09 (dd, J=16.8, 0.4 Hz, 2H), 4.95 (d, J=10.0 Hz, 2H), 3.92 (t, J=8.0, Hz, 4H), 3.53 (m, 4H), 3.39 (s, 12H), 2.74 (bs, 2H), 2.05 (q, J=7.3 Hz, 4H), 1.78 (bs, 4H), 1.27-1.36 (m, 20H). ¹³C NMR (100 MHz, CDCl₃): δ 19.1, 23.1, 26.4, 29.20, 29.27, 29.3, 29.4, 32.6, 51.4, 61.1, 66.6, 114.9, 131.1, 135.5, 137.4. IR (thin film, MeOH): 3437, 2933, 2856, 2094, 1801, 1604, 1651, 1487, 1470, 1003, 951, 899, 723, 650 cm⁻¹. HRMS (ES) calcd. for C₃₁H60BrN2 (M+M+Br−): 539.3934; observed: 539.3913.

### 1,3-Bis(tetradeca-11,13-dienyl-N,N,N′,N′-tetramethylammonium)propane dibromide (monomer 4c)

N,N,N′,N′-Tetramethyl-1,3-propanediamine (0.43 g, 0.56 mL, 3.33 mmol, 100 mol %) and 14-bromotetradeca-1,3-diene (2.00 g, 7.32 mmol, 220 mol %) were dissolved in toluene (15 mL) and acetonitrile (15 mL) in a 50-mL Schlenk flask equipped with a stir bar. The clear colorless solution was heated to 69° C. for 15 h. The white ppt. that formed after cooling to room temperature was filtered and washed with hexanes (2×10 mL), affording a white powder (1.75 g, 78%). ¹H NMR (400 MHz, CDCl₃) δ 6.31 (dt, J=10.4, 6.8 Hz, 2H), 6.05 (dd, J=10.4, 4.8 Hz, 2H), 5.71 (dd, J=14.9, 7.3 Hz, 2H), 5.08 (d, J=15.3 Hz, 2H), 4.95 (d, J=10.1 Hz, 2H), 3.92 (t, J=8.0 Hz, 4H), 3.48 (d, J=17.0 Hz, 4H), 3.35 (s, 12H), 2.77 (s, 2H), 2.12-2.03 (m, 4H), 1.84 (bs, 8H), 1.36 (s, 10H), 1.26 (s, 24H). ¹³C NMR (100 MHz, CDCl₃): δ 19.1, 23.1, 26.5, 29.3, 29.4, 29.6, 32.7, 51.4, 61.2, 66.8, 114.8, 131.0, 135.7, 137.5. IR (thin film, MeOH): 3437, 2933, 2856, 2094, 1801, 1604, 1651, 1487, 1470, 1003, 951, 899, 723, 650 cm⁻¹. HRMS (ES) calcd. for C₃₅H₆₈BrN₂ (M+M+Br−): 595.4560; observed: 595.4547.

### 1,6-Bis(deca-7,9-dienyl-N,N,N′,N′-tetramethylammonium)hexanedibromide (monomer 4d)

N,N,N′,N′-Tetramethyl-1,6-hexanediamine (1.13 g, 1.40 mL, 6.58 mmol, 100 mol %) and 10-bromodeca-1,3-diene (3.00 g, 13.82 mmol, 210 mol %) were dissolved in toluene (10 mL) and acetonitrile (20 mL) in a 50-mL Schlenk flask equipped with a stir bar. The clear colorless solution was heated to 69° C. for 15 h. The white precipitate that formed after cooling to room temperature was filtered and washed with hexanes (2×10 mL), affording a white powder (3.35 g, 84%). ¹H NMR (400 MHz, CDCl₃): δ 6.30 (dt, J=16.8, 10.0 Hz, 2H), 6.03 (dd, J=10.8, 4.4 Hz, 2H), 5.68 (dd, J=14.8, 7.6 Hz, 2H), 5.09 (d, J=16.4 Hz, 2H), 4.96 (d, J=10.4 Hz, 2H), 3.71 (m, 4H), 3.50 (m, 4H), 3.37 (s, 12H), 2.07 (m, 6H), 1.72 (bs, 4H), 1.57 (s, 6H), 1.37 (bs, 10H). ¹³C NMR (100 MHz, CDCl₃): δ 21.9, 22.9, 24.9, 26.3, 28.9, 29.0, 32.4, 51.1, 64.2, 64.6, 115.1, 131.3, 135.1, 137.3. IR (thin film, MeOH): 3437, 2933, 2856, 2094, 1801, 1604, 1651, 1487, 1470, 1003, 951, 899, 723, 650 cm⁻¹. HRMS (ES) calcd, for C₃₀H₅₈BrN₂ (M+M+Br−): 527.3762; observed: 527.3753.

### 1,6-Bis(dodeca-9,11-dienyl-N,N,N′,N′-tetramethylammonium)hexane dibromide (monomer 4e)

N,N,N′,N′-Tetramethyl-1,6-hexanediamine (0.47 g, 0.58 mL, 2.71 mmol, 100 mol %) and 12-bromododeca-1,3-diene (1.40 g, 5.71 mmol, 210 mol %) were dissolved in toluene (10 mL) and acetonitrile (10 mL) in a 50-mL Schlenk flask equipped with a stir bar. The clear colorless solution was heated to 69° C. for 15 h. The white ppt. that formed after cooling to room temperature was filtered and washed with hexanes (2×10 mL), affording a white powder (1.52 g, 86%). ¹H NMR (400 MHz, CDCl₃): δ 6.30 (dt, J=10.0, 6.4 Hz, 2H), 6.05 (dd, J=10.8, 4.8 Hz, 2H), 5.70 (dd, J=14.9, 7.6 Hz, 2H), 5.08 (d, J=16.8 Hz, 2H), 4.95 (d, J=10.4 Hz, 2H), 3.75 (m, 4H), 3.45 (m, 4H), 3.38 (s, 12H), 2.06 (m, 6H), 1.73 (bs, 6H), 1.60 (s, 4H), 1.29-1.37 (m, 18H). ¹³C NMR (100 MHz, CDCl₃): δ 21.8, 23.0, 24.6, 26.4, 29.1, 29.2, 29.41, 29.44, 32.6, 51.2, 64.3, 64.8, 114.9, 131.1, 135.6, 137.5. IR (thin film, MeOH): 3437, 2933, 2856, 2094, 1801, 1604, 1651, 1487, 1470, 1003, 951, 899, 723, 650 cm⁻¹. HRMS (ES) calcd. for C₃₄H₆₆BrN₂ (M+M+Br−): 581.4404; observed: 581.4405.

### 1,6-Bis(tetradeca-11,13-dienyl-N,N,N′,N′-tetramethylammonium)hexane dibromide (monomer 4f)

N,N,N′,N′-Tetramethyl-1,6-hexanediamine (0.63 g, 038 mL, 3.62 mmol, 100 mol %) and 14-bromotetradeca-1,3-diene (2.08 g, 7.61 mmol, 210 mol %) were dissolved in toluene (10 mL) and acetonitrile (15 mL) in a 50-mL Schlenk flask equipped with a stir bar. The clear colorless solution was heated to 69° C. for 15 h. The white ppt. that formed after cooling to room temperature was filtered and washed with hexanes (2×10 mL), affording a white powder (2.20 g, 85%). ¹H NMR (400 MHz, CDCl₃): δ 6.30 (dt, J=13.6, 8.04 Hz, 2H), 6.04 (dd, J=12.0, 8.0 Hz, 2H), 5.71 (dd, J=11.6, 5.6 Hz, 2H), 5.08 (dd, J=13.7, 0.8 Hz, 2H), 4.95 (d, J=8.4 Hz, 2H), 3.75 (m, 4H), 3.46 (m, 4H), 3.39 (s, 12H), 2.07 (m, 6H), 1.69 (m, 4H), 1.57 (s, 4H), 1.36 (m, 12H), 1.26 (bs, 16H). ¹³C NMR (100 MHz, CDCl₃): δ 21.9, 23.0, 24.7, 26.5, 29.3, 29.4, 29.5, 32.7, 51.2, 64.2, 64.8, 114.8, 131.0, 135.7, 137.5. IR (thin film, MeOH): 3437, 2933, 2856, 2094, 1801, 1604, 1651, 1487, 1470, 1003, 951, 899, 723, 650 cm⁻¹, HRMS (ES) calcd. for C₃₈H₇₄BrN₂ (M+M+Br): 637,5030; observed: 637.5010.

### Example 2

### Determination of LLC Phase Behavior

LLC samples of specific composition were made by adding an appropriate amount of monomer, water, and photoinitiator to custom made glass vials, and sealed with Teflon tape and Parafilm. LLC samples were homogenized by alternating hand mixing and centrifuging (3,500 rpm) until completely homogenous. It should be noted that the LLC samples are sensitive to evaporative water loss, so steps should be taken to keep the samples sealed as much as possible during sample mixing and transfer. The range of each LLC phase was determined using variable temperature PLM. Specimens for PLM were prepared by pressing samples of each different composition between a microscope slide and microscope coverslip. The sample was placed on the PLM thermal stage and annealed past its isotropic temperature or to 85° C. The sample was slowly cooled and allowed to come back to its room temperature phase. The sample was then heated to 95° C. at a rate of 5° C./min with image capture at every 1.25° C. and continuous recording of the light intensity. Changes in optical texture and light intensity were used to determine changes in the phase of the mixture. The identity of each observed phase was then confirmed by XRD by analyzing a point in each distinct phase region as elucidated by PLM. XRD of the samples were taken either by using a film holder apparatus for room temperature spectrums or a heated stage for higher temperature spectrums. In the film holder, a sample was placed between mylar sheets with an appropriate spacer, annealed and then placed in the film holder. On the heated stage, a sample was placed in an aluminum XRD pan and apiece of Mylar was used to cover the sample to prevent evaporation. Using the combined PLM and XRD data, phase diagrams were plotted for each monomer as a function of composition and temperature.

### Example 3

### Degree of 1,3-Diene Polymerization of Bicontinuous Cubic (Q) Phases

LLC samples of 85 wt % monomer and 15 wt % water with an additional 1 wt % photo-initiator with respect to monomer were prepared as described earlier for monomers 4c and 4f. This specific composition forms a Q_{I} phase when heated above 50° C. and 55° C. respectively. Samples were prepared for FT-IR analysis by placing a small amount between two Ge plates with an appropriate spacer and heated to 75° C. to form a Q phase. The mixtures were then examined using a FT-IR spectrometer to obtain a pre-polymerization spectrum of the mixtures. Using the same LLC samples, a small amount was placed between a Ge crystal plate and a quartz plate with the same spacer, Samples were heated to 75° C. to form a Q phase, and then irradiated with 365 nm light (850 mW.cm⁻²) for 1 h. The quartz plate was then carefully removed leaving the polymerized LLC sample on the Ge plate. The polymerized sample was then examined using a FT-IR spectrometer to obtain a post-polymerization spectrum of the mixtures. The 1004 cm⁻¹ absorbance peak in the pre-polymerized samples comes from the C—H out of plane wagging from the —CH═CH₂ located at the end of the 1,3-diene tails of the monomer. The disappearance of the 1004 cm⁻¹ in the post-polymerized samples suggest >90% degree of 1,3-diene conversion for the Q_{I} phase LLC sample. This is more than sufficient to create a highly cross-linked polymer network with monomers that each contain two chain-addition polymerizable groups.

### Example 4

### Verification of Q_{I} Phase after Polymerization

LLC samples of 85 wt % monomer and 15 wt % water with an additional 1 wt % photo-initiator with respect to monomer were prepared as described earlier for monomers 4c and 4f. This specific composition forms a Q_{I} phase when heated above 50° C. and 55° C. respectively. Samples were placed between two Mylar sheet with an appropriate spacer. The Mylar sheets prevent water loss, allow the passage of UV light for photopolymerization, and allow for easy delamination after polymerization. The mixture between Mylar sheets was then hand-pressed to form a thin film of the LLC mixture. The mixture was then heated to 75° C. and photopolymerized. The resulting thin film was delaminated and analyzed by PLM and XRD to verify Q phase in the polymerized film.

### Example 5

### Fabrication of Supported Type I Bicontinuous Cubic (Q_{I}) Membranes of Gemini Ammonium Monomer Using a Modified Hot-Pressing Method

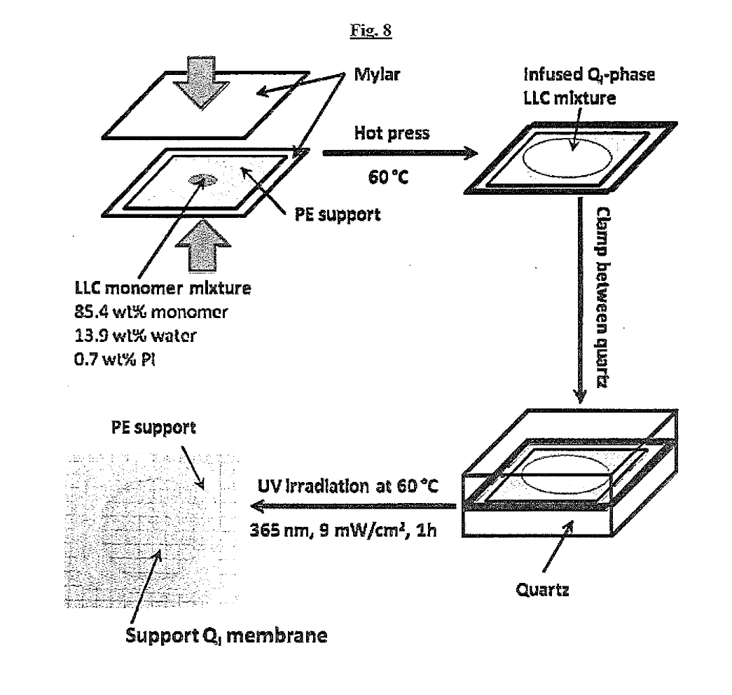

A Q_{I}-phase monomer gel mixture containing 85.4/13.9/0.7 (w/w/w) Gemini ammonium monomer/H₂O/photo initiator (2-hydroxy-2-methylpropiophenone and also refer to as PI) was prepared by alternately hand-mixing and centrifuging (3500 rpm, 5-15 min) three times or until homogeneous. This mixture was immediately used for membrane fabrication. Formation of a Q_{I} phase in the resulting optically transparent, colorless thick gel mixture was confirmed by the presence of a black optical texture under the PLM and XRD peaks with a d-spacing ratio of 1/√6:1/√8 (sometimes with an additional observed peak at 1/√20 or 1/√22). This LLC monomer mixture was then applied onto membrane support film and photo-cross-linked with retention of the LLC structure, as shown in FIG. 8. A small amount of the LLC monomer gel mixture was first placed on a piece of hydrophilic micro porous polyethylene support membrane (Solupor® E075-9H01A). Then the gel mixture together with the microporous membrane support was sandwiched between Mylar sheets and placed between 15 cm×15 cm smooth aluminum plates with a mirror-like finish. The entire assembly was then pressed using a manual press equipped with two temperature controlled platens that were pre-heated to 60° C. First, a force of 1 ton was applied for 1 min and then this was increased to 8 ton for 2-10 min to four ca. 80 cm² assemblies to infuse the monomer mixture completely through the support. The resulting infused film (still between Mylar sheets) was removed from the Al platens and clamped between two quartz plates that were pre-heated to 60° C. The assembly was maintained at this temperature for 5 min and then irradiated with a 365 nm UV light (ca. 850 mW cm⁻² at the sample surface) for 1 h to photo-cross-link the QI-phase microstructure. Optically transparent supported membranes with the QI-phase structure were obtained using this method. According to FT-IR analysis before and after photopolymerization, the degree of 1,3-diene polymerization was found to >95% (see subsequent sections on degree of polymerization characterization).

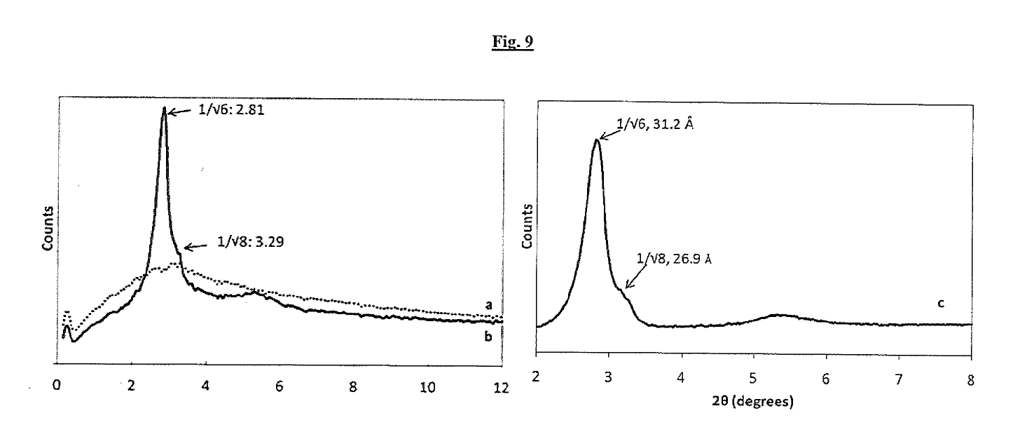

Powder XRO analysis of the supported, cross-linked LLC membranes show diffraction peaks with a d-spacing ratio of 1/√6:1/√8, which is characteristic of a Q phase with either the la3d or Pn3 in structure (FIG. 9).

### Example 6

### Aqueous NaCl Filtration Study of Supported QI-Phase Membranes

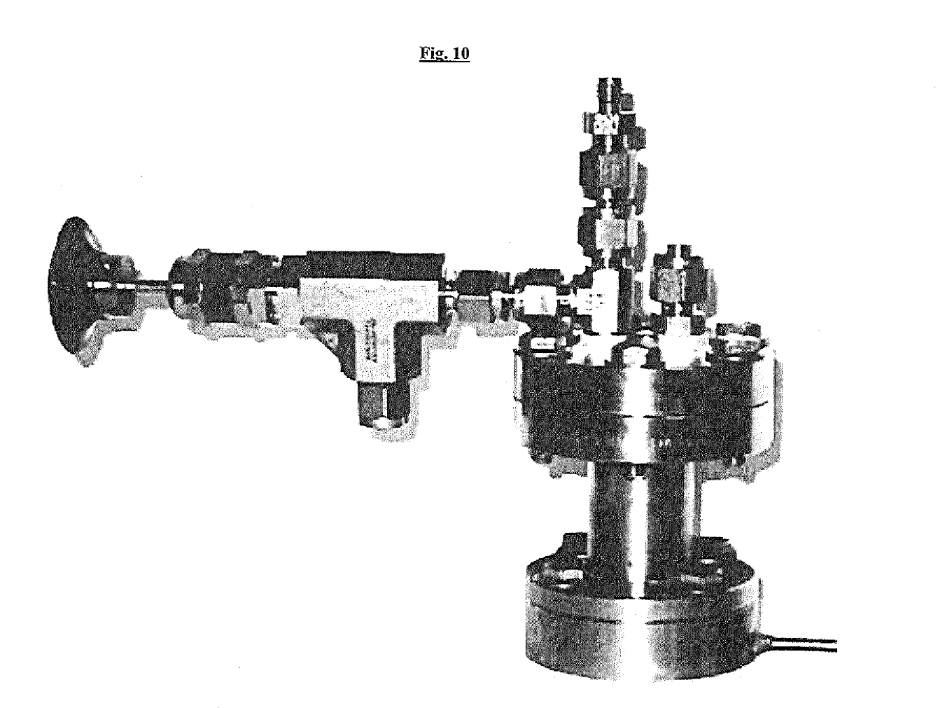

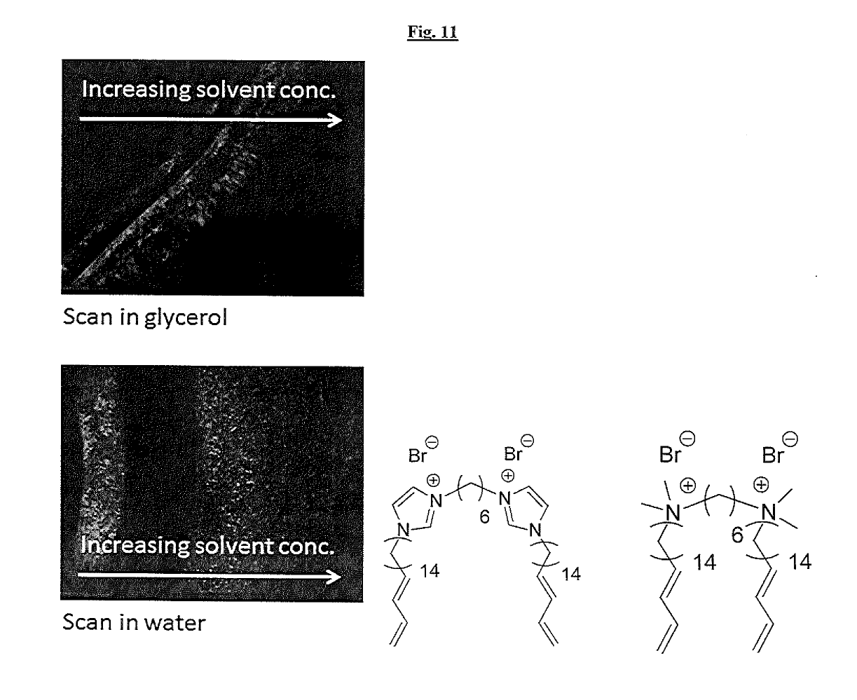

Membrane discs 2.5 cm in diameter were punched out from the membrane sheets fabricated according to Example 5. The membrane discs were assembled into a custom-made, stainless steel, stirred, membrane dead-end filtration cell with an inner diameter of 25 mm and an effective filtration area of 3.8 cm² (FIG. 10). Deionized water (DI) with a resistivity of >14 MΩcm⁻¹ was then filtered through the membrane sample under 400 psi applied N₂ pressure with stirring at ambient temperature (21±1° C.) until a steady-state flux was reached. (DI water filtration acted as a control to ascertain the membrane integrity as well as the clean membrane 01 water flux.) A 2000 ppm NaCl or MgCl₂ solution was then loaded in the cell and used for filtration studies. The first 1 mL of the permeate was discarded, and the percent rejection was obtained based on the second aliquot of permeate. The percent rejection was calculated based on the electrical conductivity of the permeate vs. that of the retentate, which was measured using a conductivity meter:

2000 ppm NaCl filtrate: (95±1) % rejection, (0.05±0.01) L m⁻² h⁻¹ flux

2000 ppm MgCl₂ filtrate: (96±1) % rejection, (0.030±0.002) L m⁻² h⁻¹ flux

These two results illustrate that membranes formed according to one embodiment of the present invention can have a similar level of performance of filtration as membranes utilizing phosphonium monomers.

### Example 7

### Water Nanofiltration Membrane Filtration

Supported membranes of the cross-linked Q phase of phosphonium monomer 3 (x=10) have uniform 0.75 nm pores and can be used as an effective water nanofiltration (NF) membrane (Thou et al., 2007, J. Amer. Chem. Soc. 2007(129):9574). These first-generation Q₁-phase membranes can almost completely remove small organic solutes and inorganic salts from water via a molecular-size-exclusion mechanism.

In order to demonstrate that the Q_{I} networks formed by the new gemini ammonium monomers afford similar size nanopores and are useful for similar separations, initial water NF tests were conducted on supported Q membranes of cross-linked 4c. To do this, supported cross-linked QI membranes of 4c were made by melt-pressing and photopolymerizing a QI-phase LLC mixture containing 84.2/14.8/1.0 (w/w/w) 2c/H₂O/PI onto the same membrane support as in prior studies (Zhou et al., 2007, JACS 2007(129):9574). However, this processing could be accomplished at lower temperatures (55-60° C.) because of the slightly different properties of the respective Q_{I} phase. This allowed for easier processing because water loss, which can disrupt the QI phase, is less of a factor.

TABLE 1
Comparison of Dead-End Water NF Performance of Cross-
Linked Q₁-Phase Membranes Prepared from 3 and 4c

| | hydrated | rejection (%)^{b} | rejection (%)^{b} |
|---|---|---|---|
| test solute | diameter (nm)^{a} | Q_{I} membrane of 3^{a} | Q_{I} membrane of 4c |
| NaCl | 0.72 (Na⁺ aq) | 95 ± 1 | 94 ± 2 |
| KCl | 0.66 (K+ aq) | 91 ± 3 | 92 ± 2 |
| MgCl₂ | 0.86 (Mg²⁺ aq) | >99.3 | 95 ± 2 |
| CaCl₂ | 0.82 (Ca²⁺ aq) | >99.3 | 96.9 ± 0.2 |
| sucrose | 0.94 | >99 | 97.9 ± 0.2 |
| glucose | 0.73 | 96 ± 2 | 94 ± 1 |
| glycerol | 0.36 | 53 ± 1 | 45 ± 11 |
| ethylene | 0.32 | 38 ± 4 | 38 ± 3 |
| glycol | | | |

^{a}Zhou et al., 2007, JACS 2007(129): 9574
^{b}All filtrations were conducted with 2000 ppm aqueous test solutions in a stirred, dead-end filtration cell with a pressure of 400 psi.

Table 1 shows that the water NF rejection performance of supported Q_{I}-phase membranes of 4c compared to that of 3 under the same test conditions. The Q_{I}-phase membranes of 4c rejected organic solutes and inorganic salts almost as well as the first-generation Q_{I} membranes based on 3. The Q membranes of 4c had a slightly larger nanopore width of 0.86 nm, according to modeling of the neutral solute rejection behavior using the modified Ferry Equation. These second generation Q_{I} membranes also afforded a similar level of throughput, with a thickness-normalized pure water permeance at 400 psi (27.6 bar) of 0.054±10.003 L.m⁻².h⁻¹.bar⁻¹.μm, which is slightly lower than that of Q_{I} membranes of 3 (0.086±0.001 L.m⁻².h⁻¹.bar⁻¹.μm) under the same conditions. However, the 4c membranes were much easier and less expensive to make in terms of the monomer.

In summary, a new Q_{I}-phase gemini LLC monomer system has been developed that is more easily and economically synthesized than prior examples. Homologues of this gemini ammonium-based monomer system exhibited Q_{I} phases that could be cross-linked with retention of the structure. Supported membranes of these materials were used for aqueous molecular size separations and exhibit uniform, sub-1 nm size pores. Systematic structural modification of the monomer 4 platform may be explored to reduce and control the effective Q_{I} nanopore size for targeted molecular-size separations. Q_{I} phase formation of homologues with solvents other than pure water (e.g., nonaqueous solvents and ionic solutions) may also be explored to evaluate if pore size can be manipulated by solvent environment. The more facile and scalable synthesis afforded by this new monomer platform makes these and other optimization studies viable. It is possible that these new Q_{I} phase monomers can be copolymerized with commercial elastomers to make nanoporous, selective vapor barrier materials in a more facile and economical fashion.

The disclosures of each and every patent, patent application, and publication cited herein are hereby incorporated herein by reference in their entirety. One skilled in the art will readily appreciate that the present invention is well adapted to carry out the objects and obtain the ends and advantages mentioned, as well as those inherent therein. While the invention has been disclosed with reference to specific embodiments, it is apparent that other embodiments and variations of this invention may be devised by others skilled in the art without departing from the true spirit and scope used in the practice of the invention. The appended claims are intended to be construed to include all such embodiments and equivalent variations.

What is claimed is:

1. A composite membrane comprising:
a porous support, and
a porous LLC polymer composition attached to the support;
wherein the LLC polymer composition forms a type I bicontinuous cubic LLC phase,
wherein the phase has a pore structure of interconnected nanopores based on the type I bicontinuous cubic LLC structure and has an effective pore size that ranges from about 0.5 nm to about 5 nm.

2. The composite membrane of claim 1, wherein the LLC polymer composition is formed by polymerizing a mixture comprising an aqueous or polar solvent and at least one ammonium-based Gemini amphiphilic monomer.

3. The composite membrane of claim 1, wherein the LLC polymer composition is embedded within the support.

4. The composite membrane of claim 1, wherein the LLC polymer composition forms a layer on the surface of the support.

5. The composite membrane of claim 1, wherein the effective pore size of the LLC polymer composition ranges from about 0.5 nm to about 2 nm.

6. The composite membrane of claim 1, wherein the pore size of the support ranges from about 0.1 μm to about 10 μm.

7. The composite membrane of claim 1, wherein the at least one amphiphilic monomer has the structure: 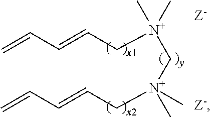
wherein:
each occurrence of x1 and x2 is independently an integer ranging from 2 to 20;
y is an integer ranging from 1 to 10; and
Z⁻ is an acceptable anion.

8. A method of preparing a composite membrane, wherein the membrane comprises a porous support and a porous LLC polymer composition embedded within the support, the method comprising the steps of:
providing a porous support;
providing a LLC mixture comprising a plurality of polymerizable amphiphilic monomers, a polymerization initiator, and an aqueous or polar organic solvent, wherein one or more of the amphiphilic monomers assembles to form a type I bicontinuous cubic LLC phase;
impregnating the support with the LLC mixture; and
cross-linking the LLC monomers, wherein the type I bicontinuous cubic LLC phase is substantially maintained during impregnation and cross-linking.

9. The method of claim 8, wherein the plurality of the polymerizable amphiphilic monomers comprises at least one ammonium-based Gemini amphiphilic monomer.

10. The method of claim 8, wherein the support is impregnated with the LLC mixture by applying heat and/or pressure to the support and LLC mixture.

11. The method of claim 8, wherein the support is hydrophilic.

12. The method of claim 8, wherein the pore size of the support ranges from about 0.5 μm to 10 μm.

13. The method of claim 8, wherein the LLC mixture does not comprise a separate hydrophobic polymer.

14. The method of claim 8, wherein the at least one amphiphilic monomer has the structure: 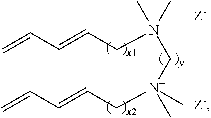
wherein:
each occurrence of x1 and x2 is independently an integer ranging from 2 to 20;
y is an integer ranging from 1 to 10; and
Z⁻ is an acceptable anion.

15. A method of preparing a composite membrane, wherein the composite membrane comprises a porous support and a porous LLC polymer composition forming a layer on the surface of the support, the method comprising the steps of:
providing a porous support;
providing a LLC mixture comprising a plurality of polymerizable amphiphilic monomers, a polymerization initiator, and an aqueous or polar solvent, wherein one or more of the amphiphilic monomers assemble to form a type I bicontinuous cubic LLC phase;
applying a layer of the LLC mixture onto the support; and
cross-linking the LLC monomers, wherein the type I continuous cubic LLC phase is substantially maintained during impregnation and cross-linking.

16. The method of claim 15, wherein the plurality of polymerizable amphiphilic monomers comprises at least one polymerizable ammonium-based Gemini amphiphilic monomer.

17. The method of claim 15, wherein the support is hydrophilic.

18. The method of claim 15, wherein the pore size of the support ranges from about 0.5 μm to 10 μm.

19. The method of claim 15, wherein the LLC mixture does not comprise a separate hydrophobic polymer.

20. The method of claim 15, wherein one or more amphiphilic monomer have the structure: 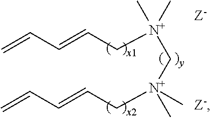
wherein:
each occurrence of x1 and x2 is independently an integer ranging from 2 to 20;
y is an integer ranging from 1 to 10; and
Z⁻ is an acceptable anion.

21. A method of separating a given component from a first fluid mixture, the method comprising the steps of:
contacting a first fluid mixture with the inlet side of a composite membrane of claim 1, wherein the first fluid mixture comprises a given component;
applying a pressure difference across the composite membrane; and
isolating from the outlet side of the composite membrane a second fluid mixture, wherein the proportion of the given component in the second fluid mixture is depleted as compared with the first fluid mixture.

22. The method of claim 21, wherein the effective pore size of the composite membrane is smaller than the molecular size of the given component.
